(19) United States
(12) Patent Application Publication
(10) Pub. No.: US 2019/0160802 A1
(43) Pub. Date: May 30, 2019

(54) HEAT TRANSFER DEVICE

(71) Applicant: DGSHAPE Corporation, Hamamatsu-shi (JP)

(72) Inventors: Yukie KANNO, Hamamatsu-shi (JP); Tamaki OGAWA, Hamamatsu-shi (JP); Jun UEDA, Hamamatsu-shi (JP)

(21) Appl. No.: 16/196,083

(22) Filed: Nov. 20, 2018

(30) Foreign Application Priority Data
Nov. 29, 2017 (JP) 2017-229115

(51) Int. Cl. B32B 41/00; B32B 37/00

(52) U.S. Cl. CPC B32B 41/00; B32B 37/025

(57) ABSTRACT

In a heat transfer device, a holder holds a presser such that a portion of the presser protrudes downward. At a position where a holding portion of the holder that is holding the presser is above an inspection surface, a first height at which a foil transfer tool collides against the inspection surface is measured. At a position where the holding portion of the holder is outward of the inspection surface and a portion of a bottom end of the holder other than the holding portion is above the inspection surface, a second height at which the foil transfer tool collides against the inspection surface is measured. If a difference between the first height and the second height is smaller than a predetermined difference, it is determined that the holder is not holding the presser.

### CROSS REFERENCE TO RELATED APPLICATIONS

This application claims the benefit of priority to Japanese Patent Application No. 2017-229115 filed on Nov. 29, 2017. The entire contents of this application are hereby incorporated herein by reference.

### BACKGROUND OF THE INVENTION

### 1. Field of the Invention

The present invention relates to a heat transfer device, and more specifically to a heat transfer device that performs foil transfer on a transfer target by use of a heat transfer foil.

### 2. Description of the Related Art

Conventionally, a decoration process is performed by a heat transfer method by use of a heat transfer foil (also referred to as a “heat transfer sheet”) for the purpose of providing a better design or the like. The heat transfer foil roughly includes a substrate, a decoration layer and an adhesive layer stacked in this order. Foil transfer is performed (namely, the heat transfer foil is transferred onto the transfer target) as follows. The heat transfer foil is stacked on the transfer target such that the adhesive layer is in contact with the transfer target, and while the heat transfer foil is pressed from above by a tool that directs laser light (e.g., a laser pen), the laser light is directed to the heat transfer foil to heat the heat transfer foil. As a result, the adhesive layer of a portion of the heat transfer foil that is pressed is melted and thus is adhered to a surface of the transfer target and is cured by heat dissipation. After this, the substrate of the heat transfer foil is peeled off from the transfer target. As a result, the decoration layer of a shape corresponding to the portion of the heat transfer foil that has been pressed is adhered to the transfer target together with the adhesive layer. In this manner, the surface of the transfer target is decorated with an intended pattern or the like.

For example, Japanese Laid-Open Patent Publication No. 2016-215599 discloses a technology for performing foil transfer on a transfer target by use of a tool that directs laser light.

A heat transfer device performing foil transfer as described above naturally needs to include a presser that presses the heat transfer foil. However, the presser is not always attached to the foil transfer tool such as a laser pen or the like because, for example, the presser, when being detachable, is not attached by mistake, or the presser has come off by malfunction or the like.

### SUMMARY OF THE INVENTION

Preferred embodiments of the present invention provide heat transfer devices that each determine whether or not a presser is held therein.

A heat transfer device disclosed herein includes a holding table, a foil transfer tool, a horizontal conveyor, a vertical conveyor, a butt, and a controller. The holding table holds a transfer target having a heat transfer foil placed thereon. The foil transfer tool includes an energy generator that generates energy to be supplied to the heat transfer foil and a holder that is capable of holding a presser that presses the heat transfer foil and transmits the energy to the heat transfer foil. The foil transfer tool is located above the holding table. The horizontal conveyor moves the foil transfer tool horizontally with respect to the holding table. The vertical conveyor moves the foil transfer tool vertically with respect to the holding table and presses the heat transfer foil on the holding table by the foil transfer tool. The butt includes an inspection surface directed upward and located in a movable region of the foil transfer tool. The holder is located at a bottom end of the foil transfer tool and holds the presser such that a portion of the presser protrudes downward from a bottom end of the holder. The controller includes a first position storage, a second position storage, a first measurer, a second measurer, and a determiner. The first position storage stores a first horizontal position as a position of the horizontal conveyor at which a holding portion of the holder that is holding the presser is above the inspection surface. The second position storage stores a second horizontal position as a position of the horizontal conveyor at which the holding portion of the holder is outward of the inspection surface and a portion of the bottom end of the holder other than the holding portion is above the inspection surface. The first measurer controls the horizontal conveyor such that the foil transfer tool moves to the first horizontal position, and then controls the vertical conveyor such that a first height at which the foil transfer tool collides against the inspection surface is measured. The second measurer controls the horizontal conveyor such that the foil transfer tool moves to the second horizontal position, and then controls the vertical conveyor such that a second height at which the foil transfer tool collides against the inspection surface is measured. The determiner compares the first height and the second height to each other, and when a difference between the first height and the second height is smaller than, or equal to, a predetermined difference, determines that the holder is not holding the presser, and when the difference between the first height and the second height is larger than the predetermined difference, determines that the holder is holding the presser.

In the above-described heat transfer device, in the state where the holder is not holding the presser, the first height is lower than in the state where the holder is holding the presser.

Therefore, in the state where the holder is not holding the presser, the difference between the first height and the second height is small. Based on this, it is determined whether or not the holder is holding the presser.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view schematically showing a heat transfer device according to a preferred embodiment of the present invention.

FIG. 2 is a partially cut perspective view schematically showing a heat transfer device according to a preferred embodiment of the present invention.

FIG. 3 is a left side view schematically showing head moving mechanisms and a holding table.

FIG. 4 is a plan view schematically showing the holding table at a maintenance position.

FIG. 5 is a plan view schematically showing the holding table at a securing position.

FIG. 6 is a vertical cross-sectional view schematically showing a structure of a head and the vicinity thereof.

FIG. 7 is a block diagram of the heat transfer device.

FIG. 8 shows examples of test patterns.

FIG. 9 is a block diagram of a heat transfer device according to a first modification of a preferred embodiment of the present invention.

FIG. 10 is a block diagram of a heat transfer device according to a second preferred modification of a preferred embodiment of the present invention.

FIG. 11 is a graph showing the relationship between the gray scale level of the pixel and the duty value.

FIG. 12 is a graph showing the relationship between the scanning rate of a foil transfer tool and the limit value.

FIG. 13 is a graph showing the relationship between the gray scale level of the pixel and the supply energy level.

FIG. 14 is a plan view showing a first horizontal position.

FIG. 15 is a plan view showing a second horizontal position.

### DETAILED DESCRIPTION OF THE PREFERRED EMBODIMENTS

Hereinafter, heat transfer devices according to preferred embodiments the present invention will be described with reference to the drawings. The preferred embodiments described herein are not intended to specifically limit the present invention. Components and portions that have the same functions will bear the same reference signs, and overlapping descriptions will be omitted or simplified.

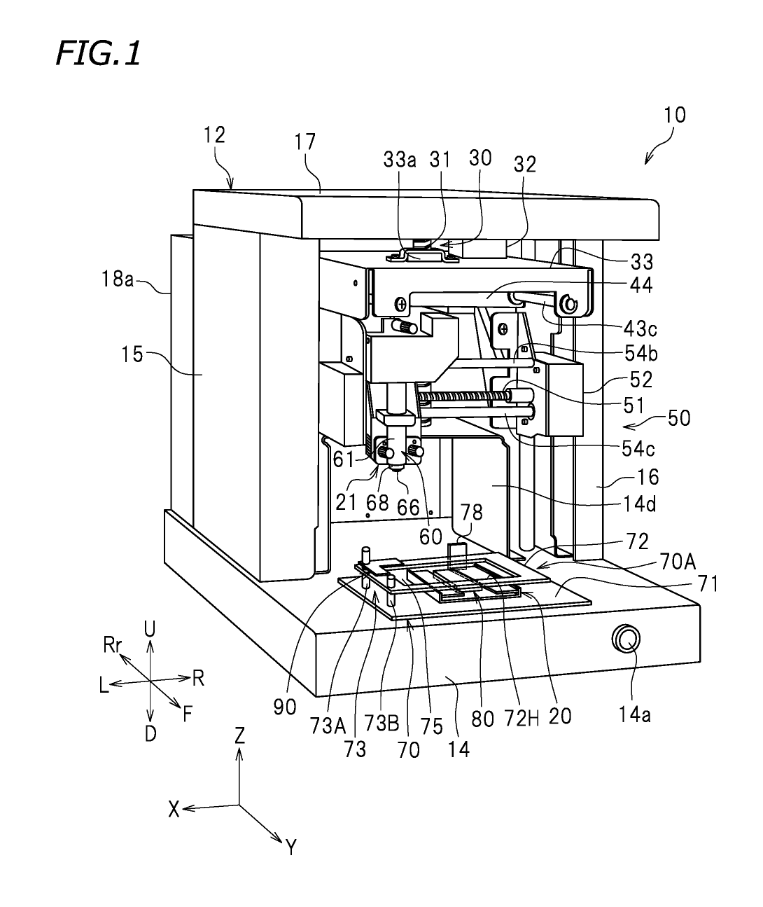

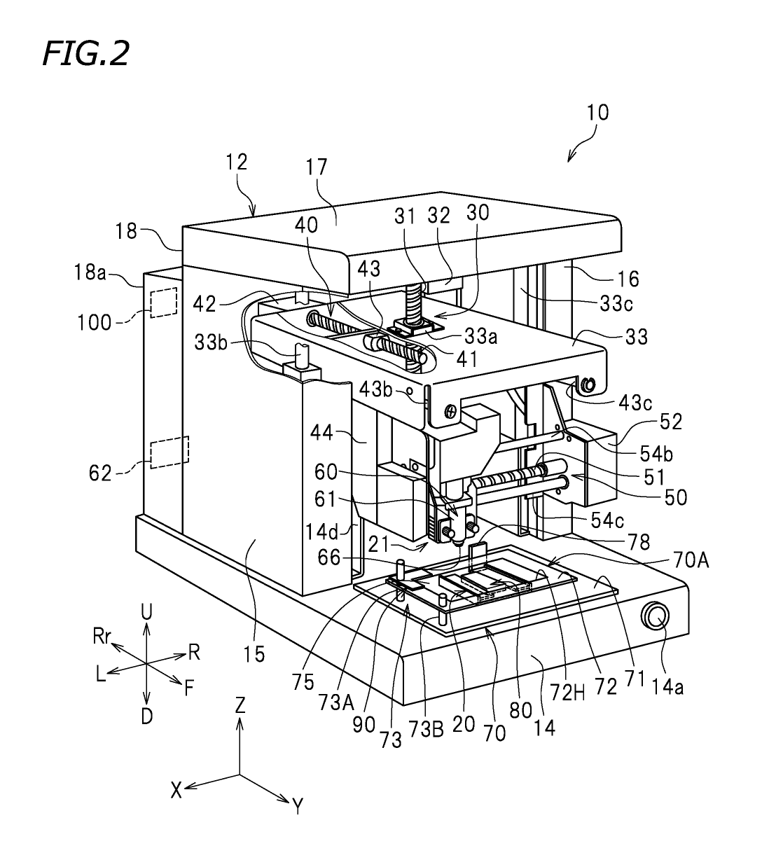

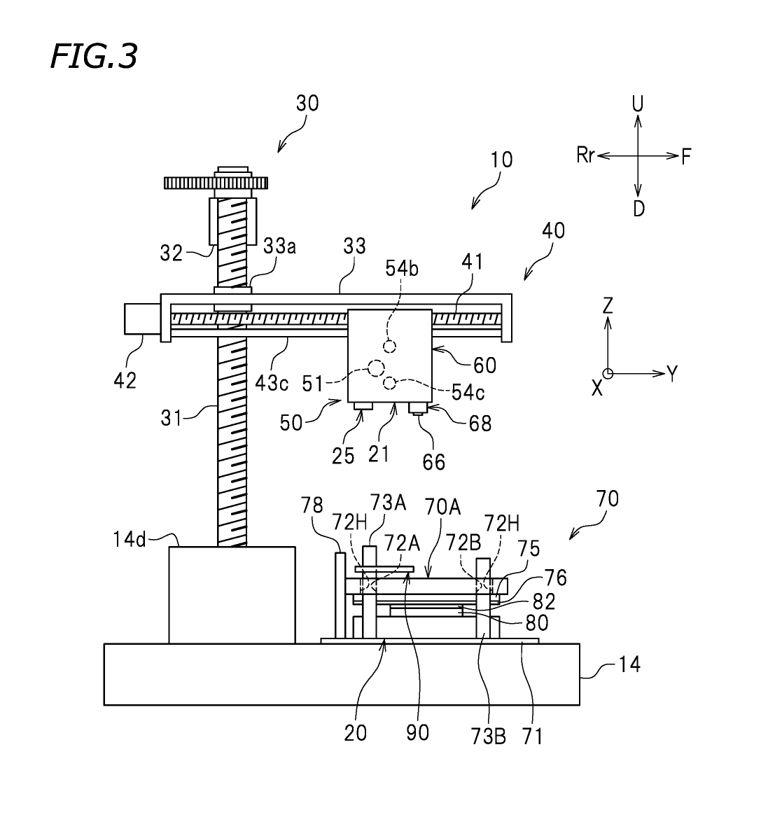

FIG. 1 is a perspective view of a heat transfer device 10. FIG. 2 is a partially cut perspective view schematically showing the heat transfer device 10. FIG. 3 is a left side view schematically showing head moving mechanisms and a holding table 70. In the following description, the terms “left”, “right”, “up” and “down” respectively refer to left, right, up and down as seen from an operator (user) looking at a power button 14a on a front surface of the heat transfer device 10. A direction approaching the heat transfer device 10 away from the operator is referred to as “rearward”, and a direction separated away from the heat transfer device 10 toward the operator is referred to as “forward”. In the drawings, letters F, Rr, L, R, U and D respectively represent front, rear, left, right, up and down. Where an X axis, a Y axis and a Z axis cross each other perpendicularly, the heat transfer device 10 in this preferred embodiment is placed on a plane defined by the X axis and the Y axis. In this preferred embodiment, the X axis extends in a left-right direction. The Y axis extends in a front-rear direction. The Z axis extends in an up-down direction. The above-described directions are merely defined for the sake of convenience, and do not limit the manner of installation of the heat transfer device 10 in any way.

As shown in FIG. 1, the heat transfer device 10 has a box-like shape. The heat transfer device 10 includes a housing 12 having a front opening, the head moving mechanisms (including a first moving mechanism 30, a second moving mechanism 40 (see FIG. 2) and a third moving mechanism 50), a head 21, and the holding table 70. As used herein, a moving mechanism is also referred to as a conveyor. The first moving mechanism 30, the second moving mechanism 40, the third moving mechanism 50, the head 21 and the holding table 70 are located in the housing 12. The housing 12 includes a bottom wall 14, a left side wall 15, a right side wall 16, a top wall 17 and a rear wall (see FIG. 2). The housing 12 is formed of, for example, a steel plate.

As shown in FIG. 2, the left side wall 15 extends upward from a left end of the bottom wall 14. The left side wall 15 is perpendicular or substantially perpendicular to the bottom wall 14. The right side wall 16 extends upward from a right end of the bottom wall 14. The right side wall 16 is perpendicular or substantially perpendicular to the bottom wall 14. The rear wall 18 extends upward from a rear end of the bottom wall 14. The rear wall 18 is connected with a rear end of the left side wall 15 and a rear end of the right side wall 16. A box-shaped case 18a is provided on the rear wall 18. The case 18a accommodates a controller 100 described below. The top wall 17 is connected with a top end of the left side wall 15, a top end of the right side wall 16 and a top end of the rear wall 18. A portion of the first moving mechanism 30 is provided in the top wall 17. A region enclosed by the bottom wall 14, the left side wall 15, the right side wall 16, the top wall 17 and the rear wall 18 is an inner space of the housing 12.

As shown in FIG. 1, the holding table 70 is provided on the bottom wall 14. The holding table 70 holds a heat transfer foil 82 (see FIG. 3), films required for heat transfer and a transfer target 80. The holding table 70 holds the transfer target 80 while having at least the heat transfer foil 82 placed thereon. In this preferred embodiment, as shown in FIG. 3, the holding table 70 holds the transfer target 80 while having the heat transfer foil 82, a light absorbing film 76 and a foil securing film 75 placed thereon. The holding table 70 includes a securing tool 20 holding the transfer target 80 and also includes a film holding tool 70A holding the light absorbing film 76 and the foil securing film 75 and pressing the heat transfer foil 82 by use of the foil securing film 75 to secure the heat transfer foil 82.

The securing tool 20 holds the transfer target 80. The securing tool 20 is, for example, a vise. The securing tool 20 is detachably attached to the holding table 70. Alternatively, the securing tool 20 may be non-detachably attached to the holding table 70.

There is no specific limitation on the material or the shape of the transfer target 80. The transfer target 80 may be formed of, for example, a resin such as acrylic resin, polyvinyl chloride (PVC), polyethyleneterephthalate (PET), polycarbonate (PC) or the like; paper such as plain paper, drawing paper, Washi (traditional Japanese paper) or the like; rubber; a metal material such as gold, silver, copper, platinum, brass, aluminum, iron, titanium, stainless steel or the like; etc.

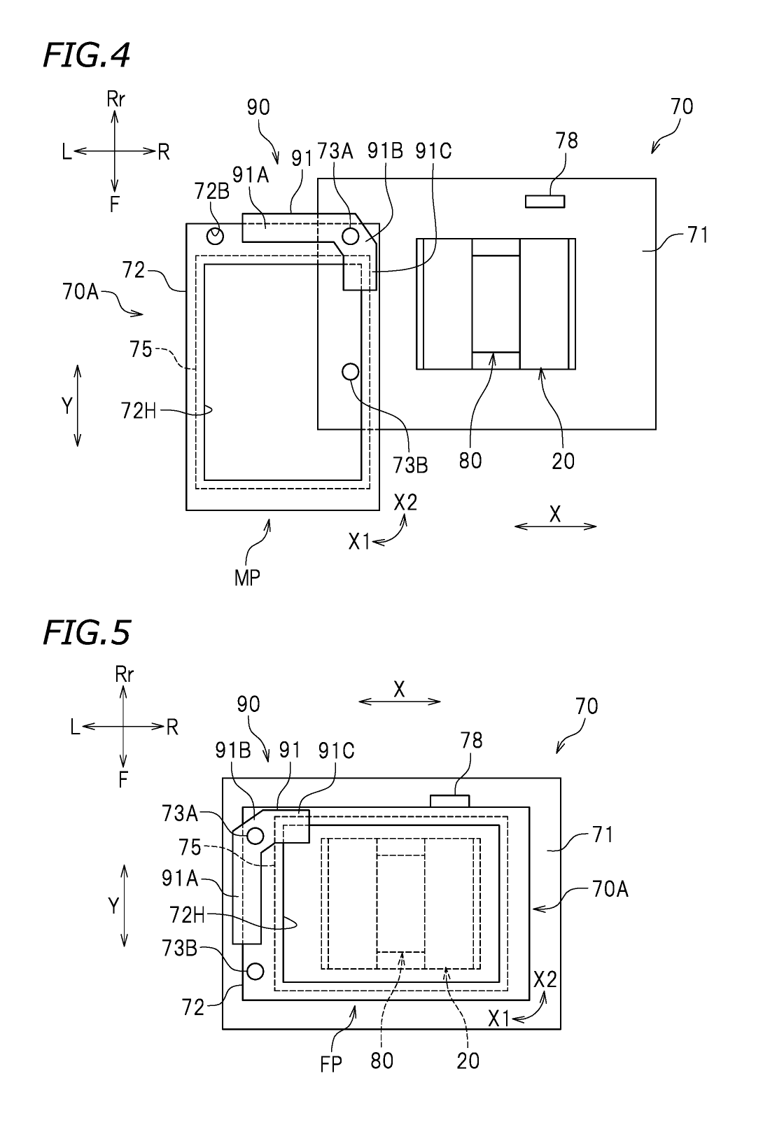

The film holding tool 70A holds the foil securing film 75 and the light absorbing film 76 located on a bottom surface of the foil securing film 75. FIG. 4 and FIG. 5 are each a plan view schematically showing the holding table 70. As described below, the holding table 70 includes a movable holding frame 72. FIG. 4 shows a state where the holding frame 72 is at a maintenance position MP described below. FIG. 5 shows a state where the holding frame 72 is at a securing position FP described below. The film holding tool 70A includes a support plate 71, the holding frame 72, a slide bar 73, and a stopper 78.

As shown in FIG. 1, the support plate 71 is provided on the bottom wall 14. The support plate 71 is flat and plate shaped. The slide bar 73 includes a first slide bar 73A and a second slide bar 73B. The first slide bar 73A and the second slide bar 73B extend upward from the support plate 71. The first slide bar 73A and the second slide bar 73B extend upward from a left end of the support plate 71. The first slide bar 73A is located to the rear of the second slide bar 73B. The first slide bar 73A and the second slide bar 73B are parallel or substantially parallel to each other. The first slide bar 73A is longer than the second slide bar 73B in the up-down direction.

The holding frame 72 holds the foil securing film 75 and the light absorbing film 76. As shown in FIG. 1, the holding frame 72 is slidable along the first slide bar 73A and the second slide bar 73B. The holding frame 72 is movable in the up-down direction. The holding frame 72 is located above the support plate 71. As shown in FIG. 3, the holding frame 72 includes a first through-hole 72A, through which the first slide bar 73A is inserted, and also includes a second through-hole 72B, through which the second slide bar 73B is inserted. The holding frame 72 is movable upward by a predetermined length to draw the second slide bar 73B from the second through-hole 72B. In this state, the holding frame 72 is supported only by the first slide bar 73A. As a result, as shown in FIG. 4, the holding frame 72 is made rotatable in a direction of arrow X1 and a direction of arrow X2 in FIG. 4 as being centered around the first slide bar 73A. The holding frame 72 is movable between the securing position FP (see FIG. 5) and the maintenance position MP (see FIG. 4). The holding frame 72 is at the securing position FP while the heat transfer foil 82 is secured to the transfer target 80 by the foil securing film 75. At the securing position FP, the holding frame 72 is above the securing tool 20. When the holding frame 72 is at the securing position FP, the first slide bar 73A is inserted into the first through-hole 72A and the second slide bar 73B is inserted into the second through-hold 72B. The holding frame 72 is at the maintenance position MP in order to replace the foil securing film 75 held by the holding frame 72 with another foil securing film, in order to detach the securing tool 20 from the holding table 70, or in order to detach the transfer target 80 secured to the securing tool 20 from the securing tool 20. When the holding frame 72 is at the maintenance position MP, the first slide bar 73A is inserted into the first through-hole 72A whereas the second slide bar 73B is not inserted into the second through-hole 72B.

As shown in FIG. 5, the holding frame 72 includes an opening 72H extending therethrough in the up-down direction. The opening 72H is rectangular or substantially rectangular, for example. The opening 72H is larger than the securing tool 20. More specifically, the opening 72H is longer than the securing tool 20 in the left-right direction, and the opening 72H is longer than the securing tool 20 in the front-rear direction. When the holding frame 72 is at the securing position FP, the securing tool 20 and the opening 72H overlap each other as seen in a plan view. More specifically, the securing tool 20 is located in the opening 72H as seen in a plan view.

The foil-securing film 75 is held by the holding frame 72 so as to overlap the opening 72H as seen in a plan view. The foil-securing film 75 is larger than the opening 72H, and is held by the holding frame 72 so as to overlap the entirety of the opening 72H as seen in a plan view. The foil-securing film 75 is held on a bottom surface of the holding frame 72. There is no specific limitation on the method for holding the foil securing film 75. For example, the foil securing film 75 is held on the bottom surface of the holding frame 72 with a two-sided tape. The light absorbing film 76 is secured to the bottom surface of the foil securing film 75. There is no specific limitation on the method for securing the light absorbing film 76 to the foil securing film 75. For example, the light absorbing film 76 is secured to the foil securing film 75 with a light-transmissive adhesive or a light-transmissive two-sided tape. The foil securing film 75 presses the heat transfer foil 82 from above. A large portion of the pressing force is provided by the weight of the holding frame 72.

The stopper 78 restricts the rotation of the holding frame 72. As shown in FIG. 1, the stopper 78 extends upward from the support plate 71. The stopper 78 is located to the rear of the first slide bar 73A. A top end of the stopper 78 is located above a top end of the second slide bar 73B. The top end of the stopper 78 is, for example, located above a top end of the first slide bar 73A. As shown in FIG. 5, when the holding frame 72 is at the securing position FP, the stopper 78 restricts the holding frame 72 from rotating in the direction of arrow X2 in FIG. 5. When the holding frame 72 is at the securing position FP, the stopper 78 is in contact with the holding frame 72. When the holding frame 72 is at the securing position FP, the holding frame 72 may be moved upward by a predetermined length to draw the second slide bar 73B from the second through-hole 72B. In the state where the holding frame 72 is moved from the maintenance position MP (see FIG. 4) to the securing position FP to put the holding frame 72 into contact with the stopper 78, the second through-hole 72B and the second slide bar 73B overlap each other as seen in a plan view. At this point, the holding frame 72 may be moved downward to insert the second slide bar 73B into the second through-hole 72B. In this manner, the stopper 78 is also used to align the positions of the second through-hole 72B and the second slide bar 73B.

A bonded body of the foil securing film 75 and the light absorbing film 76 presses the heat transfer foil 82 from above to secure the heat transfer foil 82 to the transfer target 80. Namely, the transfer target 80 and the films are stacked in the order of the transfer target 80, the heat transfer foil 82, the light absorbing film 76 and the foil securing film 75 from below to above. When, for example, the holding frame 72 is at the maintenance position MP, the heat transfer foil 82 is placed on the transfer target 80. Then, when the holding frame 72 is moved to the securing position FP, the heat transfer foil 82 is secured onto the transfer target 80 by the bonded body of the foil securing film 75 and the light absorbing film 76.

The foil securing film 75 preferably is made of a material that is significantly lower in the light absorbance than the light absorbing film 76. The foil securing film 75 is light-transmissive. The foil securing film 75 is, for example, transparent. The foil securing film 75 has a higher strength than that of the light absorbing film 76. The foil securing film 75 preferably may have a thickness of, for example, about 25 μm to about 100 μm. There is no specific limitation on the material of the foil securing film 75. The foil securing film 75 may be made of, for example, a plastic material such as polyester or the like.

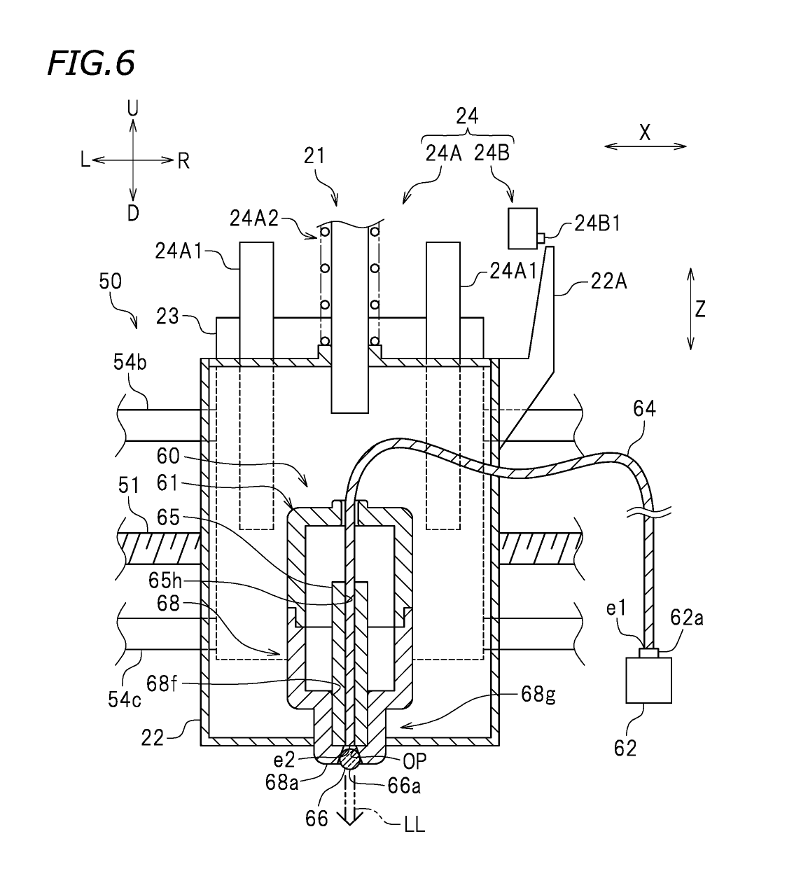

The light absorbing film 76 efficiently absorbs light of a predetermined wavelength range (laser light) emitted from a light source 62 (see FIG. 6) of a foil transfer tool 60 and converts the optical energy into thermal energy. The light absorbing film 76 may be made of, for example, a resin such as polyimide or the like. The light absorbing film 76 is resistant against heat of a temperature of, for example, about 100° C. to about 200° C.

The heat transfer foil 82 is heated and pressed to transfer a decoration layer thereof to a surface of the transfer target 80. In this preferred embodiment, the heat transfer foil 82 performs foil transfer by use of optical energy of light emitted by the light source 62 of the foil transfer tool 60. The heat transfer foil 82 may be any common transfer foil commercially available for heat transfer with no specific limitation. The heat transfer foil 82 generally includes a substrate, the decoration layer, and an adhesive layer stacked in this order. The decoration layer of the heat transfer foil 82 may be, for example, a metallic foil such as a gold foil, silver foil or the like, a half metallic foil, a pigment foil, a multi-color printed foil, a hologram foil, an electrostatic discharge-preventive foil or the like. In this preferred embodiment, the light absorbing film 76 is separate from the heat transfer foil 82. Alternatively, the heat transfer foil 82 may include a light absorbing layer having a function equivalent to that of the light absorbing film 76. In such a case, the light absorbing film 76 does not need to be included. The light absorbing layer may have a thickness of, for example, about 1 μm to about 15 μm.

As shown in FIG. 1, a butt member 90 is attached to a top surface of the holding frame 72 of the film holding tool 70A. The butt member 90 is usable to check whether or not a presser 66 (see FIG. 6), which is to be held at a tip of the foil transfer tool 60, is actually held. As shown in FIG. 5, the butt member 90 includes an inspection surface 91C, which is directed upward and is located in a movable region of the foil transfer tool 60. When the holding frame 72 is at the securing position FP, the inspection surface 91C is located in the movable region of the foil transfer tool 60. The butt member 90 includes a plate 91 and a spacer (not shown). The plate 91 is flat. As shown in FIG. 5, the plate 91 includes a secured portion 91A and an inspection portion 91B. The secured portion 91A is secured to the holding frame 72, more specifically, to a region of the holding frame 72 where the first through-hole 72A and the second through-hole 72B are located. The inspection portion 91B is bent from the secured portion 91A toward the opening 72H of the holding frame 72. As shown in FIG. 5, when the holding frame 72 is at the secured position FP, a tip of the inspection portion 91B partially overlap the opening 72H as seen in a plan view. A top surface of the tip of the inspection portion 91B is the inspection surface 91C. The inspection surface 91C is a horizontal surface located mainly in the opening 72H as seen in a plan view. The plate 91 is secured to be horizontal above the holding frame 72 via the spacer (not shown). The spacer separates the plate 91 from the top surface of the holding frame 72. Namely, the plate 91 is located above the top surface of the holding frame 72.

In the inner space of the housing 12, the heat transfer foil 82 is foil-transferred to the transfer target 80. The head 21 and the head moving mechanisms moving the head 21 in a three-dimensional direction are accommodated in the inner space. The head moving mechanisms include the first moving mechanism 30 moving the head 21 in the Z-axis direction, the second moving mechanism 40 moving the head 21 in the Y-axis direction, and the third moving mechanism 50 moving the head 21 in the X-axis direction. The head 21 is movable with respect to the holding table 70 by the first moving mechanism 30, the second moving mechanism 40 and the third moving mechanism 50. The first moving mechanism 30, the second moving mechanism 40 and the third moving mechanism 50 are all located above the bottom wall 14.

The first moving mechanism 30 moves the foil transfer tool 60 mounted on the head 21 in a vertical direction with respect to the holding table 70 and thus causes the foil transfer tool 60 to press the heat transfer foil 82 on the holding table 70. As shown in FIG. 1, the first moving mechanism 30 is a screw feeding mechanism including a Z-axis direction feed screw stock 31, a Z-axis direction feed motor 32, and a feed nut 33a. The Z-axis direction feed screw stock 31 extends in the Z-axis direction. The Z-axis direction feed screw stock 31 includes a spiral thread groove. A top portion of the Z-axis direction feed screw stock 31 is secured to the top wall 17. A top end of the Z-axis direction feed screw stock 31 extends through a bottom surface of the top wall 17 in the Z-axis direction, and a portion thereof is located inside the top wall 17. A bottom end of the Z-axis direction feed screw stock 31 is rotatably supported by a frame 14d (see also FIG. 3). The frame 14d is secured to the bottom wall 14. The Z-axis direction feed motor 32 is an electric motor. The Z-axis direction feed motor 32 is connected with the controller 100 (see FIG. 2). The Z-axis direction feed motor 32 is secured to the top wall 17. A driving shaft of the Z-axis direction feed motor 32 extends through the bottom surface of the top wall 17 in the Z-axis direction, and a portion thereof is located inside the top wall 17. Inside the top wall 17, the Z-axis direction feed screw stock 31 is coupled with the Z-axis direction feed motor 32. The Z-axis direction feed motor 32 rotates the Z-axis direction feed screw stock 31.

As shown in FIG. 2, the Z-axis direction feed screw stock 31 is engaged with the feed nut 33a including a screw thread. The feed nut 33a is coupled with an elevatable base 33. The feed nut 33a extends through a top surface of the elevatable base 33 in the Z-axis direction. The elevatable base 33 is supported by the Z-axis direction feed screw stock 31 via the feed nut 33a. The elevatable base 33 is parallel or substantially parallel to the bottom wall 14. Slide shafts 33b and 33c each extending in the Z-axis direction are located inward of the left side wall 15 and the right side wall 16, respectively. The slide shafts 33b and 33c are parallel or substantially parallel to the Z-axis direction feed screw stock 31. The elevatable base 33 is attached to the slide shafts 33b and 33c to be slidable in the Z-axis direction. When the Z-axis direction feed motor 32 is driven, the elevatable base 33 moves, by the rotation of the Z-axis direction feed screw stock 31, in the up-down direction along the slide shafts 33b and 33c. The second moving mechanism 40 and the third moving mechanism 50 are coupled with the elevatable base 33. Therefore, the second moving mechanism 40 and the third moving mechanism 50 integrally move in the up-down direction along with the movement of the elevatable base 33 in the up-down direction.

As shown in FIG. 2, the second moving mechanism 40 moves the head 21 in the Y-axis direction (in the front-rear direction). The second moving mechanism 40 is a screw feeding mechanism including a Y-axis direction feed screw stock 41, a Y-axis direction feed motor 42, and a feed nut 43. The Y-axis direction feed screw stock 41 extends in the Y-axis direction. The Y-axis direction feed screw stock 41 is provided in the elevatable base 33. The Y-axis direction feed screw stock 41 includes a spiral thread groove. A rear end of the Y-axis direction feed screw stock 41 is coupled with the Y-axis direction feed motor 42. The Y-axis direction feed motor 42 is an electric motor. The Y-axis direction feed motor 42 is connected with the controller 100. The Y-axis direction feed motor 42 is secured to a rear surface of the elevatable base 33. The Y-axis direction feed motor 42 rotates the Y-axis direction feed screw stock 41. The thread groove of the Y-axis direction feed screw stock 41 is engaged with the feed nut 43, which includes a screw thread. The elevatable base 33 is provided with a pair of slide shafts 43b and 43c each extending in the Y-axis direction. The two slide shafts 43b and 43c are located parallel or substantially parallel to the Y-axis direction feed screw stock 41. A slide base 44 is attached to the slide shafts 43b and 43c to be slidable in the Y-axis direction. When the Y-axis direction feed motor 42 is driven, the slide base 44 moves, by the rotation of the Y-axis direction feed screw stock 41, in the front-rear direction along the slide shafts 43b and 43c.

As shown in FIG. 1, the third moving mechanism 50 moves the head 21 in the X-axis direction (in the left-right direction). The third moving mechanism 50 is a screw feeding mechanism including an X-axis direction feed screw stock 51 and an X-axis direction feed motor 52. The X-axis direction feed screw stock 51 extends in the X-axis direction. The X-axis direction feed screw stock 51 is provided to the front of the slide base 44. The X-axis direction feed screw stock 51 includes a spiral thread groove. An end of the X-axis direction feed screw stock 51 is coupled with the X-axis direction feed motor 52. The X-axis direction feed motor 52 is an electric motor. The X-axis direction feed motor 52 is connected with the controller 100 (see FIG. 2). The X-axis direction feed motor 52 is secured to a portion of the right side wall 16 that extends to the front of the slide base 44. The X-axis direction feed motor 52 rotates the X-axis direction feed screw stock 51. The thread groove of the X-axis direction feed screw stock 51 is engaged with a nut (not shown) provided in the head 21. A pair of slide shafts 54b and 54c each extending in the X-axis direction are provided to the front of the slide base 44. The two slide shafts 54b and 54c are located parallel or substantially parallel to the X-axis direction feed screw stock 51. The head 21 is attached to the slide shafts 54b and 54c to be slidable in the X-axis direction. When the X-axis direction feed motor 52 is driven, the head 21 moves, by the rotation of the X-axis direction feed screw stock 51, in the left-right direction along the slide shafts 54b and 54c. The second moving mechanism 40 and the third moving mechanism 50 are included in a horizontal moving mechanism. The horizontal moving mechanism moves the foil transfer tool 60 mounted on the head 21 in a horizontal direction with respect to the holding table 70.

The head 21 has the foil transfer tool 60 mounted thereon. FIG. 6 is a vertical cross-sectional view schematically showing a structure of the head 21 and the vicinity thereof. As shown in FIG. 6, the head 21 has the foil transfer tool 60 mounted thereon. As shown in FIG. 3, in this preferred embodiment, the head 21 has a camera 25 mounted thereon. The camera 25 is capable of capturing an image of components on the holding table 70.

The foil transfer tool 60 presses the heat transfer foil 82 placed on the transfer target 80 and also directs light toward the heat transfer foil 82 to supply heat to the heat transfer foil 82. The foil transfer tool 60 is located above the holding table 70. The light directed toward the foil securing film 75 is transmitted through the foil securing film 75 and is directed toward the light absorbing film 76. The foil transfer tool 60 includes the light source 62, a pen main body 61, and the presser 66 secured to a bottom end of the pen main body 61.

The light source 62 generates energy to be supplied to the heat transfer foil 82. The light source 62 supplies light, acting as a heat source, to the light absorbing layer of the heat transfer foil 82 or the light absorbing film 76. The light source 62 is located in the inner space of the housing 12. The light supplied to the light absorbing layer of the heat transfer foil 82 or the light absorbing film 76 is converted into thermal energy by the light absorbing layer or the light absorbing film 76, and thus heats the heat transfer foil 82. In this preferred embodiment, the light source 62 includes a laser diode (LD), an optical system and the like. The light source 62 is connected with the controller 100. The controller 100, for example, turns on the light source 62 to cause the light source 62 to emit the laser light, or turns off the light source 62 to cause the light source 62 to stop the emission of the laser light, and adjusts the level of energy of the laser light. The light source 62 is capable of adjusting the level of energy to be supplied to the heat transfer foil 82. The response speed of the laser light is high. Therefore, for example, the switching of the light source 62 to emit or stop the emission of the laser light, and the change in the level of energy of the laser light, are performed instantaneously. This allows laser light having desired properties to be directed toward the light absorbing layer of the heat transfer foil 82 or the light absorbing film 76.

The pen main body 61 has an elongated cylindrical shape. The pen main body 61 is located such that a longitudinal direction thereof matches the up-down direction Z. An axis of the pen main body 61 extends in the up-down direction. The pen main body 61 accommodates an optical fiber 64 and a ferrule 65. The pen main body 61 includes a holder 68 described below. The holder 68 is at the bottom end of the pen main body 61.

The optical fiber 64 is a fiber light transmission medium that transmits light directed from the light source 62. The optical fiber 64 includes a core portion (not shown) through which light is transmitted, and a clad portion (not shown) covering the core portion and reflecting light. The optical fiber 64 is connected with the light source 62. A top end el of the optical fiber 64 extends outward of the pen main body 61. The end el of the optical fiber 64 is inserted into a connector 62a attached to the light source 62. With such a structure, the optical fiber 64 is connected with the light source 62 in the state where the optical loss of the optical fiber 64 is significantly reduced to a relatively low amount. The ferrule 65 is attached to a bottom end e2 of the optical fiber 64. The ferrule 65 is a cylindrical photojunction member. The ferrule 65 includes a through-hole 65h along a cylindrical axis thereof. The end e2 of the optical fiber 64 is inserted into the through-hole 65h of the ferrule 65.

The pen main body 61 includes the holder 68. The holder 68 holds the presser 66 at a predetermined position of the bottom end of the pen main body 61. The holder 68 is located at a bottom end of the foil transfer tool 60. The holder 68 holds the presser 66 such that a portion of the presser 66 protrudes below a bottom end 68a of the holder 68. The presser 66 is detachable from the holder 68.

The presser 66 presses the heat transfer foil 82 and also transmits energy to the heat transfer foil 82. The presser 66 presses the heat transfer foil 82 indirectly, namely, via the foil securing film 75 and the light absorbing film 76. The presser 66 is preferably made of a hard material. There is no precise limitation on the hardness of the presser 66, but the presser 66 may preferably be made of a material having a Vickers hardness of, for example, 100 Hv_{0.2} or greater (e.g., 500 Hv_{0.2} or greater). The presser 66 may be made of, for example, glass. In this preferred embodiment, the presser 66 is preferably made of synthetic quartz glass. The presser 66 is spherical or substantially spherical. The presser 66 is preferably made of a material that transmits the light emitted from the light source 62. The presser 66 is held, by the holder 68, on an optical path LL of the laser light. Thus, the laser light emitted from the light source 62 is transmitted through the presser 66 and reaches the light absorbing film 76. The presser 66 transmits the energy of the laser light emitted from the light source 62 to the heat transfer foil 82 via the light absorbing film 76.

The holder 68 also holds the ferrule 65 at a predetermined position at the bottom end of the pen main body 61. The holder 68 is cap-shaped. A top portion of the holder 68 is cylindrical with an outer diameter corresponding to the pen main body 61. A bottom portion of the holder 68 includes a protrusion 68g having an outer diameter shorter than the diameter of the top portion of the holder 68. The protrusion 68g includes a ferrule holding portion 68f, which is recessed and cylindrical. The ferrule holding portion 68f has an inner diameter corresponding to an outer diameter of the ferrule 65. The ferrule holding portion 68f accommodates a bottom end of the ferrule 65.

The holder 68 includes an opening OP extending therethrough in the up-down direction. The core portion of the optical fiber 64 at the end e2 is exposed outside via the opening OP. Namely, the core portion of the optical fiber 64 at the end e2 overlaps the opening OP as seen in a bottom view. With such a structure, the holder 68 does not interfere with the optical path LL of the laser light. As a result, the laser light emitted from the light source 62 is allowed to be directed outside from the bottom end of the pen main body 61.

The head 21 has the camera 25 (see FIG. 3), capable of capturing an image of the components on the holding table 70, mounted thereon. The camera 25 acquires an image of a test pattern and a barcode (both described below) foil-transferred to the transfer target 80. The camera 25 defines and functions as an image capturing device that acquires an image of the test pattern and a barcode reading device that reads the barcode. In this preferred embodiment, the camera 25 is mounted on the head 21. Alternatively, the camera 25 may be provided at any other position. For example, the camera 25 may be externally provided to the heat transfer device 10. In such a case, the transfer target 80 may be transported to such an area that may be image-captured by the camera 25 while the transfer target 80 is secured to the securing tool 20, which is detachable.

As shown in FIG. 6, the head 21 includes a head main body 22, an engaging member 23, and a sensor 24. The head main body 22 holds the foil transfer tool 60 and the camera 25. The engaging member 23 is engaged with the third moving mechanism 50. The head main body 22 is engaged with the engaging member 23 via a slide mechanism 24A (described below) of the sensor 24. The sensor 24 senses that the head main body 22 having the foil transfer tool 60 mounted thereon has been pressed upward. The head main body 22 is pressed upward in the case where, for example, the foil transfer tool 60 is lowered and as a result, the bottom end thereof collides against an object. The object is, for example, the butt member 90 or the transfer target 80.

The engaging member 23 is engaged with the third moving mechanism 50. The third moving mechanism 50 moves the head 21 in the X-axis direction via the engaging member 23. The engaging member 23 includes a feed nut (not shown) engaged with the X-axis direction feed screw stock 51 of the third moving mechanism 50, and also includes a bush (not shown) engaged with the slide shafts 54b and 54c. The sensor 24 is attached to a front surface of the engaging member 23. The sensor 24 includes the slide mechanism 24A holding the head main body 22 and the components mounted thereon such that the head main body 22 and the components mounted thereon are movable in the up-down direction. The sensor 24 also includes a sensor 24B that senses that the foil transfer tool 60 has moved upward with respect to the slide mechanism 24A. The slide mechanism 24A includes two slide shafts 24A1 and a spring mechanism 24A2. The slide shafts 24A1 extend in the up-down direction. The slide shafts 24A1 are engaged with the head main body 22. The head main body 22 is movable in the up-down direction along the slide shafts 24A1. The slide shafts 24A1 hold the head main body 22 having the foil transfer tool 60 mounted thereon such that the head main body 22 is movable in the up-down direction. The spring mechanism 24A2 of the slide mechanism 24A is located above the head main body 22. The spring mechanism 24A2 includes a spring. The spring of the spring mechanism 24A2 is located in a compressed state. The spring mechanism 24A2 presses the head main body 22 downward by a restoring force of the spring. The head main body 22 does not move upward with respect to the engaging member 23 unless being pressed upward by a pressing force larger than the pressing force of the spring mechanism 24A2.

The head main body 22 includes a protrusion 22A. In this preferred embodiment, the protrusion 22A is provided on a right side surface of the head main body 22. The protrusion 22A is an arm extending upward. The sensor 24B of the sensor 24 is located in the vicinity of a top end of the protrusion 22A. The sensor 24B senses that the head main body 22 having the foil transfer tool 60 mounted thereon has moved upward. The sensor 24B is, for example, a mechanical sensor including a switch. The sensor 24B does not need to be a mechanical sensor, and may be, for example, a photoelectric sensor or the like. The sensor 24B includes a switch 24B1 protruding externally. When the first moving mechanism 30 lowers the head 21, if there is any object below the head main body 22, the head main body 22 collides against the object. When the first moving mechanism 30 further lowers the head 21 by a force larger than the elastic force of the spring mechanism 24A2 from the state where the head main body 22 collides against the object, the head main body 22 moves upward along the slide shaft 24A1. The protrusion 22A presses the switch 24B1 of the sensor 24B when the head main body 22 moves upward by a predetermined length with respect to the engaging member 23. In this preferred embodiment, the sensor 24B is turned on when the switch 24B1 is pressed. The sensor 24B is connected with the controller 100. When the sensor 24B is turned on, the controller 100 senses that the foil transfer tool 60 has collided against an object and presses the object.

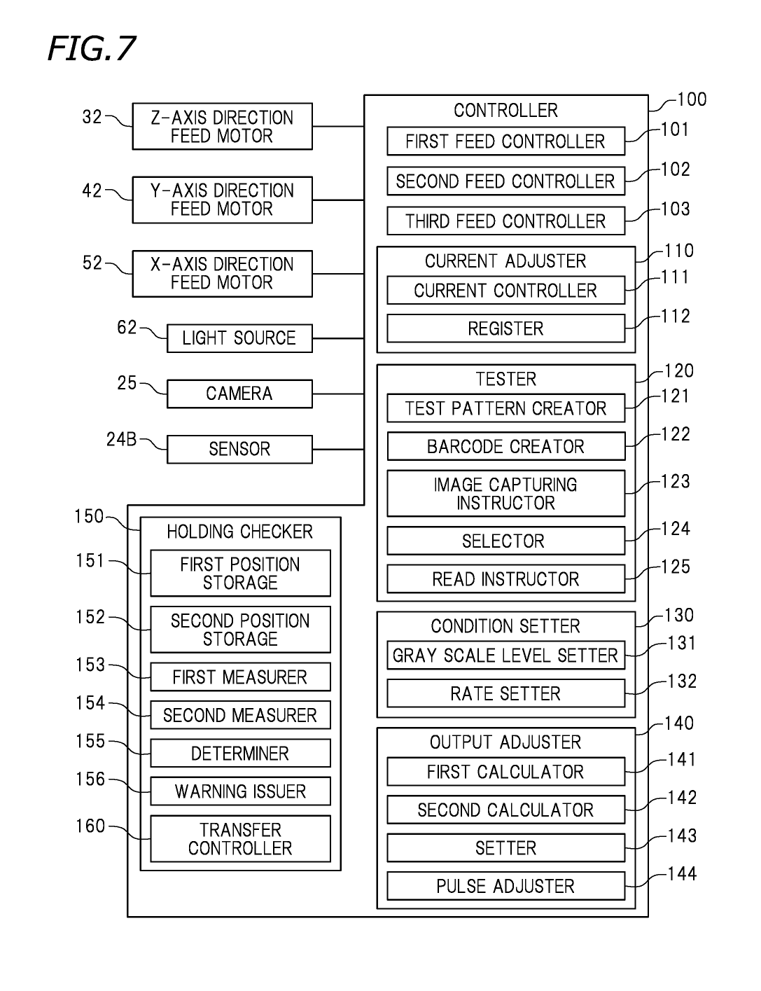

The overall operation of the heat transfer device 10 is controlled by the controller 100. FIG. 7 is a block diagram of the heat transfer device 10 in this preferred embodiment. As shown in FIG. 7, the controller 100 is communicably connected with, and controls, the Z-axis direction feed motor 32, the Y-axis direction feed motor 42, the X-axis direction feed motor 52, the light source 62 and the camera 52. The controller 100 is connected with the sensor 24B, and receives a signal from the sensor 24B. The controller 100 is typically a computer. The controller 100 includes, for example, an interface (I/F) receiving foil transfer data or the like from an external device such as a host computer or the like, a central processing unit (CPU) executing a command from a control program, a ROM storing the program to be executed by a CPU, a RAM usable as a working area where the program is developed, and a storage, such as a memory or the like, storing the above-described program and various types of data.

As shown in FIG. 7, the controller 100 includes a first feed controller 101, a second feed controller 102, a third feed controller 103, a current adjuster 110, a tester 120, a condition setter 130, an output adjuster 140, a holding checker 150, and a transfer controller 160.

The first feed controller 101 controls the Z-axis direction feed motor 32 to control an operation of the first moving mechanism 30. The motions, in the Z-axis direction, of the head 21 and the foil transfer tool 60 and the like mounted on the head 21 are controlled by the first feed controller 101.

The second feed controller 102 controls the Y-axis direction feed motor 42 to control an operation of the second moving mechanism 40. The motions, in the Y-axis direction, of the head 21 and the foil transfer tool 60 and the like mounted on the head 21 are controlled by the second feed controller 102.

The third feed controller 103 controls the X-axis direction feed motor 52 to control an operation of the third moving mechanism 50. The motions, in the X-axis direction, of the head 21 and the foil transfer tool 60 and the like mounted on the head 21 are controlled by the third feed controller 103.

The current adjuster 110 adjusts the value of electric current to be supplied to the light source 62 in order to cause the light source 62 to emit light. In the heat transfer device 10 in this preferred embodiment, the value of electric current to be supplied to the light source 62 is constant regardless of the transfer conditions. In this preferred embodiment, the value of electric current is adjusted in order to adjust differences among individual light sources including the light source 62. The current adjuster 110 adjusts the value of electric current to be supplied to the light source 62, in order to reduce or prevent variance in the transfer quality due to differences among individual light sources including the light source 62. The current adjuster 110 includes a current controller 111 and a register 112. The register 112 registers the value of electric current to be supplied to the light source 62. The current controller 111 controls the value of electric current to be supplied to the light source 62 to the value registered in the register 112. As described below in more detail, the output value of the light emitted by the light source 62 is adjusted by adjusting the time duration in which the light is directed. Such a time duration is controlled by the output adjuster 140.

The tester 120 controls a work of foil-transferring a plurality of test patterns in order to determine the value of electric current to be supplied to the light source 62, and also selects a preferred one among the plurality of test patterns foil-transferred. The tester 120 includes a test pattern creator 121, a barcode creator 122, an image capturing instructor 123, a selector 124, and a read instructor 125. The test pattern creator 121 foil-transfers the plurality of test patterns to the transfer target 80. The plurality of test patterns are respectively adjusted to different values of electric current. Shapes and the like of the test patterns will be described below. The barcode creator 122 foil-transfers a plurality of barcodes, respectively corresponding to the plurality of test patterns, to the transfer target 80. In each of the plurality of barcodes, a value of electric current used to foil-transfer the corresponding test pattern to the transfer target 80 is written. The image capturing instructor 123 controls the camera 25 such that the camera 25 captures an image of the components on the holding table 70. In this preferred embodiment, the image capturing instructor 123 causes the camera 25 to capture images of the plurality of test patterns and the plurality of barcodes foil-transferred to the transfer target 80. The selector 124 selects one preferred test pattern based on the images captured by the camera 25. The read instructor 125 causes the camera 25 defining and functioning as a barcode reading device to read the barcode corresponding to the test pattern selected by the selector 124. The value of electric current written in the barcode read by the camera 25 by the instruction of the read instructor 125 is registered in the register 112 of the current adjuster 110 as a value of electric current to be used in the heat transfer device 10.

The condition setter 130 sets the gray scale level of a pixel in the foil transfer and the rate at which the foil transfer tool 60 is to move (scanning rate of the foil transfer tool 60) in the foil transfer. The condition setter 130 includes a gray scale level setter 131 and a rate setter 132. The gray scale level setter 131 sets the gray scale level of the pixel in the foil transfer. The rate setter 132 sets the scanning rate of the foil transfer tool 60 in the foil transfer.

The output adjuster 140 controls the light source 62 to adjust the level of energy of the light to be directed toward the heat transfer foil 82. The output adjuster 140 includes a first calculator 141, a second calculator 142, a setter 143, and a pulse adjuster 144. The first calculator 141, the second calculator 142 and the setter 143 perform a calculation to set the level of energy to be supplied to each of the pixels. The setter 143 sets the level of energy to be supplied to each pixel based on the duty value and the limit value (both described below) calculated by the first calculator 141 and the second calculator 142. A method of the calculation will be described below. Based on the setting made by the setter 143, the pulse adjuster 144 adjusts the level of energy to be supplied to each pixel by adjusting the time duration in which the light is to be directed. In more detail, the pulse adjuster 144 supplies electric power to the light source 62 by pulses and adjusts the output of the light source 62 by adjusting the pulses.

The holding checker 150 checks whether or not the holder 68 is holding the presser 66 before the foil transfer is performed, and if not, issues a warning. The presser 66 is detachable from the holder 68. If the foil transfer is performed in the state where the holder 68 is not holding the presser 66, it is highly possible that the foil transfer is not performed in a satisfactory manner. For this reason, the holding checker 150 checks whether or not the holder 68 is holding the presser 66 before the foil transfer is performed. The holding checker 150 includes a first position storage 151, a second position storage 152, a first measurer 153, a second measurer 154, a determiner 155, and a warning issuer 156. The first position storage 151 stores a first horizontal position. The first horizontal position is a position of the second moving mechanism 40 and the third moving mechanism 50 at which a portion of the holder 68 that is holding the presser 66 is above the inspection surface 91C of the butt member 90. The second position storage 152 stores a second horizontal position. The second horizontal position is a position of the second moving mechanism 40 and the third moving mechanism 50 at which a portion of the holder 68 that is holding the presser 66 is outward of the inspection surface 91C and a portion of the bottom end 68a of the holder 68 that is not holding the presser 66 is above the inspection surface 91C. The first measurer 153 measures the height at which the foil transfer tool 60 collides against the inspection surface 91C of the butt member 90 when the second moving mechanism 40 and the third moving mechanism 50 are at the first horizontal position. The second measurer 154 measures the height at which the foil transfer tool 60 collides against the inspection surface 91C of the butt member 90 when the second moving mechanism 40 and the third moving mechanism 50 are at the second horizontal position. It is determined, by a signal from the sensor 24B, whether or not the foil transfer tool 60 has collided against the inspection surface 91C. Based on the measurement results of the first measurer 153 and the second measurer 154, the determiner 155 determines whether or not the holder 68 is holding the presser 60. The measurement of the heights and the determination on whether or not the holding 68 is holding the presser 66 will be described below. When the determiner 155 determines that the holder 68 is not holding the presser 66, the warning issuer 156 issues a warning.

The transfer controller 160 controls various components based on the foil transfer data such that the foil transfer is performed. The foil transfer data is data on a graphic pattern or the like that is input by the user. The transfer controller 160 controls the Y-axis direction feed motor 42 and the X-axis direction feed motor 52 via the second feed controller 102 and the third feed controller 103 respectively, such that the foil transfer tool 60 moves in the horizontal direction. The transfer controller 160 controls the Z-axis direction feed motor 32 via the first feed controller 101, such that the foil transfer tool 60 presses the heat transfer foil 82. The transfer controller 160 also controls the light source 62 via the current adjuster 110 and the output adjuster 140, such that the heat transfer foil 82 is heated via the light absorbing film 76.

The foil transfer is performed as follows. First, the transfer target 80 and the heat transfer foil 82 are set on the holding table 70. In this preferred embodiment, the transfer target 80 is secured to the securing tool 20, and the securing tool 20 is set at a predetermined position in the holding table 70. The heat transfer foil 82 is, for example, bonded to the foil securing film 75 and the light absorbing film 76 attached to the holding frame 72 of the film securing tool 70A. The holding frame is located at the securing position FP, and thus the heat transfer foil 82 is placed on, and secured to, the transfer target 80.

In the state where the heat transfer foil 82 is secured to the transfer target 80, the transfer controller 160 of the controller 100 executes the foil transfer based on the foil transfer data. The transfer controller 160 drives the Z-axis direction feed motor 32 to cause the presser 66 held by the foil transfer tool 60 to press the heat transfer foil 82 and the like. The transfer controller 160 drives the Y-axis direction feed motor and the X-axis direction feed motor 52 to cause the foil transfer tool 60 to move in the horizontal direction. At the same time, the transfer controller 160 actuates the light source 62 at a predetermined timing based on the foil transfer data. At this point, in a region to which the laser light from the light source 62 is directed after being transmitted through the foil securing film 75, the light absorbing film 76 absorbs the laser light and thus converts the optical energy into thermal energy. As a result, the light absorbing film 76 generates heat, and the heat is transmitted to the adhesive layer of the heat transfer foil 82. This causes the adhesive layer to be softened and express the adhesiveness. The adhesive layer is adhered to surfaces of the decoration layer and the transfer target 80 and thus puts the decoration layer and the transfer target 80 into close contact with each other. Then, the foil transfer tool 60 moves or the emission of the laser light from the light source 62 is stopped, and thus the supply of the optical energy to the above-mentioned region is finished. When this occurs, the adhesive layer is cooled by heat dissipation and thus is cured. As a result, the surfaces of the decoration layer and the transfer target 80 are fixed to each other. Thus, the foil transfer in the above-mentioned region is finished. The above-described operation is performed in different regions in the horizontal direction, and thus the foil transfer to the transfer target 80 is finished.

The heat transfer device 10 in this preferred embodiment has unique features in the adjustment, setting and checking performed before the foil transfer to the transfer target 80 is performed as described above. Specifically, the heat transfer device 10 has unique features in the adjustment of the value of electric current to be supplied to the light source 62, the setting of the output of the light source 62 in accordance with the gray scale level of the pixel and the scanning rate of the foil transfer tool 60 in the foil transfer, and the checking on whether or not the holding 68 is holding the presser 66. Hereinafter, each of the operations performed before the foil transfer will be described in detail.

The heat transfer device 10 in this preferred embodiment is capable of adjusting the value of electric current to be supplied to the light source 62 as one of initial settings performed on the heat transfer device 10. In this preferred embodiment, the light source 62 includes a laser diode. In general, individual laser diodes are varied in the output. In other words, when an electric current of a certain same value is supplied, the different individual laser diodes emit light of different output values. In order to stabilize the transfer quality, it is possible to adjust the value of electric current in order to allow the light source 62 to emit light of a certain output value. In this preferred embodiment, a preferred value of electric current is set by use of a test pattern foil-transferred to the transfer target 80.

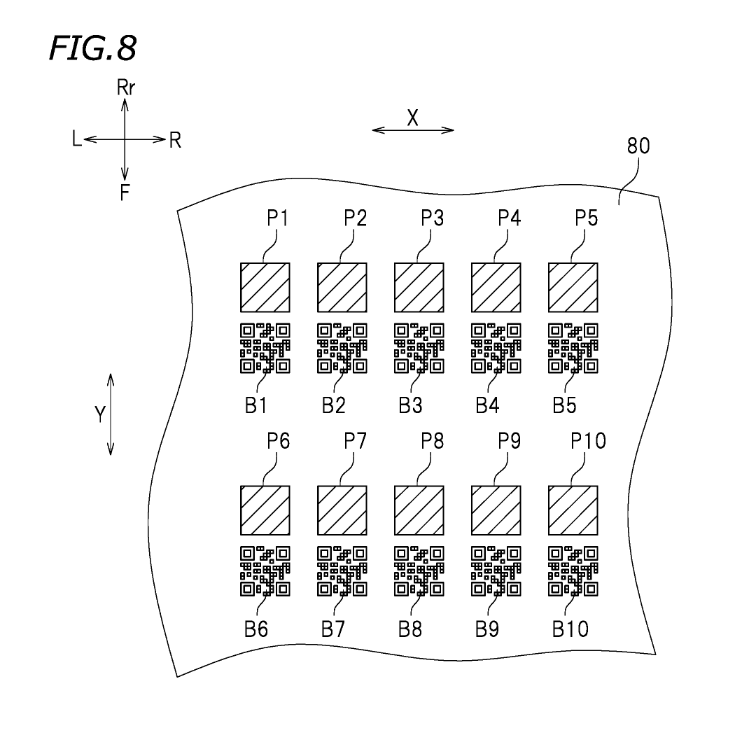

FIG. 8 shows examples of test pattern to be foil-transferred by the heat transfer device 10 in this preferred embodiment. As shown in FIG. 8, in this preferred embodiment, 10 test patterns P1 through P10 are foil-transferred to the transfer target 80. The plurality of test patterns P1 through P10 are foil-transferred at different values of electric current supplied to the light source 62. In this preferred embodiment, a first test pattern P1 is foil-transferred at the smallest value of electric current, a second test pattern P2 is foil-transferred at the second smallest value of electric current, and a third test pattern P3 is foil-transferred at the third smallest value of electric current. In this manner, the values of electric current supplied to the light source 62 increases from the first test pattern P1 to a tenth test pattern P10. The value of electric current supplied to the light source 62 is largest for the tenth test pattern P10. The test patterns P1 through P10 are regularly located on the transfer target 80. In more detail, the test patterns P1 through P5 are arrayed in a line with an equal interval, and the test patterns P6 through P10 are arrayed in a different line with the equal interval. The test patterns P1 through P10 are all squares entirely having a single color, and are foil-transferred under the same conditions except for the value of electric current.

Two-dimensional barcodes B1 through B10 are foil-transferred to the front of the 10 test patterns P1 through P10 (in FIG. 8, below the 10 test patterns P1 through P10), respectively. The 10 test patterns P1 through P10 and the 10 barcodes B1 through B10 define ten pairs. More specifically, the first test pattern P1 corresponds to, and defines a pair with, a first barcode B1. The second test pattern P2 corresponds to, and defines a pair with, a second barcode B2. In this manner, the other test patterns respectively correspond to, and define pairs with, the other barcodes. The tenth test pattern P10 corresponds to, and defines a pair with, a tenth barcode B10. In a barcode corresponding to one test pattern, the value of electric current supplied to the light source 62 to foil-transfer the corresponding test pattern is written. For example, in the first barcode B1, the value of electric current supplied to the light source 62 to foil-transfer the first test pattern P1 is written.

The pairs of the plurality of test patterns and the plurality of barcodes as shown in FIG. 8 are foil-transferred based on the control performed by the tester 120 of the controller 100. The test pattern creator 121 of the tester 120 controls the light source 62, the first moving mechanism 30, the second moving mechanism 40 and the third moving mechanism 50 such that the test patterns P1 through P10 are foil-transferred at predetermined positions in the transfer target 80. The barcode creator 122 of the tester 120 controls the first moving mechanism 30, the second moving mechanism 40 and the third moving mechanism 50 such that the barcodes B1 through B10 are foil-transferred at predetermined positions in the transfer target 80.

Images of the plurality of test patterns P1 through P10 foil-transferred and the barcodes B1 through B10 corresponding thereto also foil-transferred are captured by the camera 25 by an instruction from the image capturing instructor 123 of the tester 120. Thus, the test patterns P1 through P10 and the barcodes B1 through B10 are incorporated as images into the controller 100. In this preferred embodiment, one preferred test pattern is selected by the selector 124 of the tester 120 based on the incorporated images.

There are various conceivable methods for selecting one test pattern based on the images of the test patterns. In this preferred embodiment, a test pattern with the smallest missing portion, the least blur or the like is selected as the optimal test pattern. In this preferred embodiment, the selector 124 measures a luminance value distribution for each of the ten test patterns P1 through P10. A test pattern in which the area exhibiting a luminance value lower than a predetermined luminance value is smallest is selected as the optimal pattern. Namely, in this preferred embodiment, the selector 124 determines that an area, in a test pattern, exhibiting a luminance value higher than, or equal to, the predetermined luminance value is an area foil-transferred in a good manner. The selector 124 determines that an area, in a test pattern, exhibiting a luminance value lower than the predetermined luminance value is an area foil-transferred with a missing portion, blur or the like. Therefore, the selector 124 determines that a test pattern in which the area exhibiting a luminance value lower than the predetermined luminance value is smallest is a test pattern with the smallest missing portion, the least blur or the like.

When one preferred test pattern is selected by the selector 124, the read instructor 125 of the tester 120 causes the camera 25 defining and functioning as a barcode reading device to read the barcode corresponding to the selected test pattern. In the preferred embodiment, the expression “reading of the barcode” includes reading of a content written in the barcode. The camera has already captured the entirety of the test pattern and barcode as an image. Therefore, the “reading of the barcode” refers to reading of the content of the barcode. The content of the barcode is the value of electric current supplied to foil-transfer the test pattern corresponding to the barcode. After this, the register 112 of the current adjuster 110 registers the value of electric current, read by the camera 25 by the instruction from the read instructor 125, as the value of electric current to be used by the heat transfer device 10.

As described above, the heat transfer device 10 in this preferred embodiment may adjust the value of electric current to be supplied to the light source 62 in accordance with the characteristics of the individual light source 62 and thus may stabilize the transfer quality.

Alternatively, the adjustment of the value of electric current to be supplied to the light source 62 described above may be carried out by some preferred modifications. For example, in one preferred modification, the work of selecting one test pattern from the plurality of test patterns may be performed by the user or the like. Therefore, a heat transfer device in this preferred modification does not need to include a camera that captures the images of the test patterns, and merely needs to include a barcode reading device.

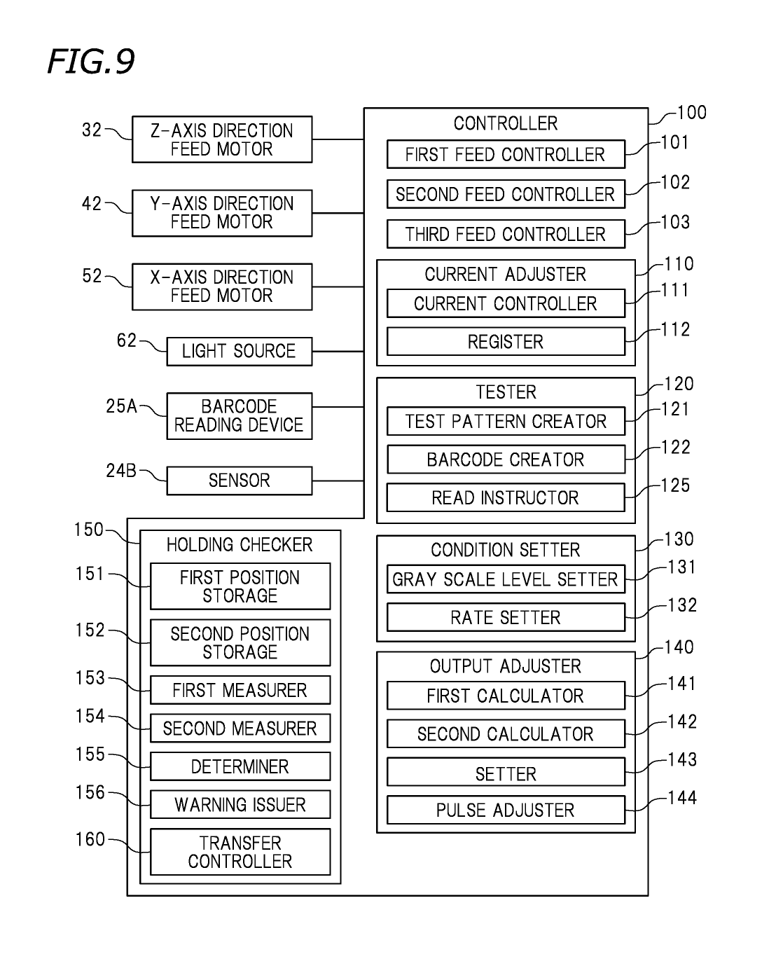

FIG. 9 is a block diagram of a heat transfer device 10 in this preferred modification. As shown in FIG. 9, the heat transfer device 10 in this preferred modification includes a barcode reading device 25A. The barcode reading device 25A is, for example, a barcode reader. In this preferred modification, the heat transfer foil 10 does not include the camera 25. The controller 100 includes neither the image capturing instructor 123 nor the selector 124. As can be seen, in this preferred modification, the heat transfer device 10 does not need to include the camera 25, the image capturing instructor 123, the selector 124 or the like. The read instructor 125 causes, for example, a display device of a computer to display an operation screen that instructs the barcode reading device 25A to read the barcode. The user or the like, for example, causes the barcode reading device 25A to approach the barcode corresponding the test pattern selected by a visual checking or the like by the user himself/herself, and operates the operation screen. The operation made on the operation screen causes the barcode reading device 25A to read the value of electric current written in the barcode corresponding to the selected test pattern. The process of foil-transferring the plurality of test patterns and the plurality of barcodes corresponding thereto to the transfer target 80 is substantially the same as in the above-described preferred embodiment. The value of electric current read by the instruction from the read instructor 125 is registered in the register 112 in substantially the same manner as in the above-described preferred embodiment. In this preferred modification, the value of electric current to be supplied to the light source 62 may be selected in comprehensive consideration of the transfer quality including glossiness and the like as well as the missing portion, blur and the like.

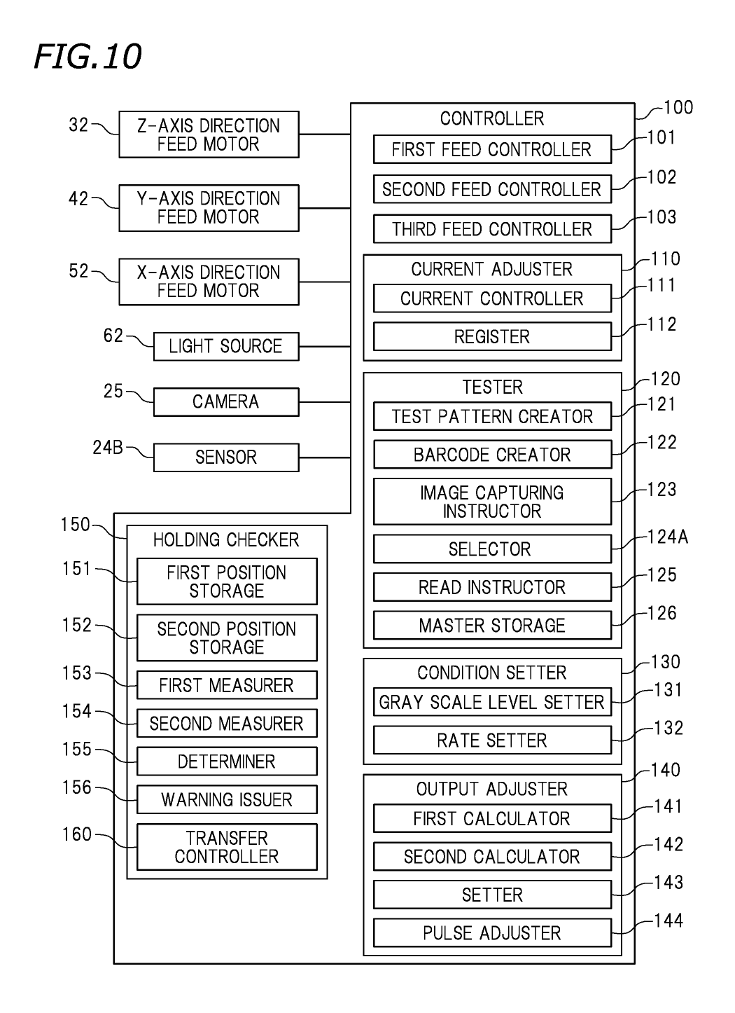

In another preferred modification, the value of electric current to be supplied to the light source 62 may be adjusted by use of a thermochromic sheet instead of the transfer target 80 having the heat transfer foil 82 placed thereon. FIG. 10 is a block diagram of a heat transfer device 10 in this preferred modification. As shown in FIG. 10, in this preferred modification, the tester 120 of the controller 100 further includes a master storage 126. The master storage 126 stores the luminance value of a predetermined master pattern transferred to the thermochromic sheet. In this preferred modification, the test pattern creator 121 and the barcode creator 122 respectively transfer the test patterns and the barcodes to the thermochromic sheet, not to the transfer target 80 having the heat transfer foil 82 placed thereon.

The thermochromic sheet, when being heated, has a color of the heated portion changed. The thermochromic sheet exhibits a color change degree corresponding to the applied heat. For example, when being strongly heated, the thermochromic sheet exhibits a high color change degree. When being weakly heated, the thermochromic sheet exhibits a low color change degree. The color change degree of the thermochromic sheet may be compared based on the luminance value in an image. In this preferred modification, a selector 124A measures the luminance value of each of a plurality of test patterns transferred to the thermochromic sheet, based on the images thereof, and selects a test pattern having a luminance value closest to the luminance value of the master pattern stored on the master storage 126. The master pattern is prepared in advance as a sample exhibiting a preferred foil transfer quality.

The master pattern is prepared as follows, for example. First, a plurality of test patterns are foil-transferred to the transfer target 80 by one heat transfer device. Like in preferred modification 1, one test pattern is selected from the plurality of test patterns. For the selection, the missing portion, blur and the like in the foil transfer, and also the glossiness and the like, may be comprehensively evaluated. There is no specific limitation on the method for evaluation. Then, a test pattern is transferred to the thermochromic sheet by the same heat transfer device at the value of electric current used to foil-transfer the selected test pattern. The test pattern transferred to the thermochromic sheet is the master pattern. The master pattern transferred to the thermochromic sheet is captured as an image, and the luminance value thereof is measured. The resultant luminance value is the luminance value of the master pattern stored on the master storage 126.

The value of electric current used to create the master pattern is a preferred value inherent to the heat transfer device used to create the master pattern, and in many cases, is not a preferred value of electric current for the other heat transfer devices. However, according to the knowledge of the present inventor, a plurality of test patterns transferred to a thermochromic sheet by a plurality of heat transfer devices at values of electric current respectively preferred to the heat transfer devices exhibit a generally similar luminance value. A test pattern having a luminance value similar to that of the master pattern is generally a preferred test pattern for a heat transfer device, even if the heat transfer device is different from the heat transfer device used to create the master pattern. Therefore, such a method is usable to adjust the value of electric current to be supplied to the light source 62 in accordance with the characteristics of the individual light source 62. Namely, the heat transfer device 10 in this preferred modification may adjust the value of electric current to be supplied to the light source to a preferred value automatically in comprehensive consideration of the transfer quality.

The above-described adjustment of the value of electric current to be supplied to the light source 62 may be summarized as follows. A heat transfer device according to a preferred embodiment disclosed herein, includes:

a holding table that holds a transfer target having a heat transfer foil placed thereon;

a foil transfer tool including an energy generator that generates energy to be supplied to the heat transfer foil, the foil transfer tool being located above the holding table;

a horizontal moving mechanism that moves the foil transfer tool horizontally with respect to the holding table;

a vertical moving mechanism that moves the foil transfer tool vertically with respect to the holding table and presses the heat transfer foil on the holding table by the foil transfer tool;

a barcode reading device; and

a controller including:
a test pattern creator that controls the foil transfer tool, the horizontal moving mechanism and the vertical moving mechanism such that a plurality of test patterns adjusted to different energy levels from each other are transferred to the transfer target;
a barcode creator that controls the foil transfer tool, the horizontal moving mechanism and the vertical moving mechanism such that a plurality of barcodes, respectively corresponding to the plurality of test patterns and each having an energy level of the corresponding test pattern written therein, are transferred to the transfer target;
a read instructor that causes the barcode reading device to read one of the plurality of barcodes; and
a register that registers the energy level written in the barcode read by the barcode reading device as the energy level to be used.

With a heat transfer device of such a structure, the energy level (in the above-described preferred embodiment, the value of electric current) of the energy generator (in the above-described preferred embodiment, the light source 62) may be adjusted to provide a preferred energy level for each individual heat transfer device. This heat transfer device encompasses the heat transfer devices in the above-described preferred embodiment and the first preferred modification.

A second heat transfer device includes, in addition to the elements of the above-described heat transfer device, an image capturing device that captures an image of components on the holding table; wherein

the controller includes:
an image capturing instructor that causes the image capturing device to capture images of the plurality of test patterns; and
a selector that selects one of the plurality of test patterns based on the captured images of the plurality of test patterns; wherein
the read instructor causes the barcode reading device to read the barcode corresponding to the selected test pattern.

With a heat transfer device of such a structure, the energy level of the energy generator may be adjusted automatically. This heat transfer device encompasses the heat transfer device in the above-described preferred embodiment.

A third heat transfer device includes, in addition to the elements of the above-described second heat transfer device, the limitation that the selector measures a luminance value distribution of each of the plurality of test patterns, and selects a test pattern including a smallest area exhibiting a luminance value lower than a predetermined luminance value.

With a heat transfer device of such a structure, the energy level of the energy generator may be adjusted automatically and with certainty. This heat transfer device encompasses the heat transfer device in the above-described preferred embodiment.

A fourth heat transfer device is a heat transfer device, includes:

a holding table that holds a transfer target having a heat transfer foil or a thermochromic sheet placed thereon;

a foil transfer tool including an energy generator that is capable of adjusting the level of energy to be supplied to the heat transfer foil or the thermochromic sheet, the foil transfer tool being located above the holding table;

a horizontal moving mechanism that moves the foil transfer tool horizontally with respect to the holding table;

a vertical moving mechanism that moves the foil transfer tool vertically with respect to the holding table and presses the heat transfer foil or the thermochromic sheet by the foil transfer tool;

an image capturing device that captures an image of components on the holding table; and

a controller including:
a master storage that stores a luminance value of a predetermined master pattern transferred to the thermochromic sheet;
a test pattern creator that controls the foil transfer tool, the horizontal moving mechanism and the vertical moving mechanism such that a plurality of test patterns adjusted to different energy levels from each other are transferred to the thermochromic sheet;
a barcode creator that controls the foil transfer tool, the horizontal moving mechanism and the vertical moving mechanism such that a plurality of barcodes, respectively corresponding to the plurality of test patterns and each having an energy level of the corresponding test pattern written therein, are transferred to the thermochromic sheet;
an image capturing instructor that causes the image capturing device to capture images of the plurality of test patterns;
a selector that measures the luminance value of each of the plurality of test patterns based on the images of the plurality of test patterns and selects one of the test patterns having a luminance value closest to the luminance value of the stored master pattern;
a read instructor that causes the barcode reading device to read the barcode corresponding to the selected test pattern; and
a register that registers the energy level written in the barcode read by the barcode reading device as the energy level to be used.

With a heat transfer device of such a structure, the energy level of the energy generator may be adjusted automatically and after comprehensive evaluation. This heat transfer device encompasses the heat transfer device in the second preferred modification.

In the above-described four heat transfer devices, the energy generator includes a light source, and the heat transfer foil is transferred by the energy of the light emitted by the light source.

A heat transfer device that adjusts the energy level of the energy generator by the above-described method is effective to a system that performs transfer using light.

A method for setting the energy level in the heat transfer device disclosed herein is a method for setting an energy level to be used in a heat transfer device including an energy generator capable of adjusting the level of thermal energy to be supplied to a heat transfer foil and a barcode reading device, the method including:
transferring, to a transfer target, a plurality of test patterns adjusted to different energy levels from each other and a plurality of barcodes respectively corresponding to the plurality of test patterns and each having an energy level of the corresponding test pattern written therein;
selecting one test pattern from the plurality of test patterns;
causing the barcode reading device to read the barcode corresponding to the selected test pattern; and
registering the energy level written in the barcode read by the barcode reading device as the energy level to be used.

With this method, the energy level (in the above-described preferred embodiment, the value of electric current) of the energy generator (in the above-described preferred embodiment, the light source 62) may be adjusted to provide a preferred energy level for each individual heat transfer device.

In the above-described preferred embodiments and preferred modifications, the test patterns preferably are squares entirely having a single color, for example. Alternatively, the shape and the size of the test patterns, whether or not the test patterns entirely have a single color, or other specifications may be set appropriately. The number and the positional arrangement of the test patterns may be set appropriately. The barcodes merely need to be paired with the test patterns, and do not need to be located side by side with the test patterns. For example, the test patterns may be arrayed in a particular region, and the barcodes may be arrayed outward of the region of the test patterns.

The heat transfer device 10 in this preferred embodiment is capable of adjusting the output of the light source 62 in accordance with the gray scale level of the pixel and the scanning rate in the foil transfer. In this preferred embodiment, the value of electric current to be supplied to the light source 62 may be set for each individual heat transfer device 10, and the output of the light source 62 is adjusted by adjusting the time duration in which the light source 62 is on and the time duration in which the light source 62 is off.

In this preferred embodiment, the controller 100 includes the condition setter 130, and the conditions for the foil transfer are set by the condition setter 130. The gray scale level setter 131 of the condition setter 130 sets the gray scale level of the pixel. The “gray scale level of the pixel” is an index corresponding to the color darkness of each of the pixels. As the gray scale level is to be raised (as the color darkness of the foil transfer is to be raised), a higher level of energy is required to be supplied to each of the pixels. In this preferred embodiment, the gray scale level may be set to any one of 256 levels from 0 to 255. It should be noted that the number of the gray scale levels is not limited to 256, and may be set in various manners. The rate setter 132 sets the scanning rate at which the horizontal moving mechanism moves the foil transfer tool 60 in the foil transfer. In this preferred embodiment, the scanning rate of the foil transfer tool 60 is the rate at which the third moving mechanism 50 moves the foil transfer tool 60 in the X-axis direction.

The output adjuster 140 controls the light source 62 such that the optical energy to be directed toward the heat transfer foil 82 is adjusted. The output adjuster 140 adjusts the output of the light source 62 in accordance with the conditions of the foil transfer set by the condition setter 130. The output adjuster 140 includes the first calculator 141, the second calculator 142, the setter 143, and the pulse adjuster 144. The first calculator 141 calculates a duty value. The “duty value” is a level of energy calculated for each of the pixels, and increases along with the gray scale level of the pixel (described below in more detail). The second calculator 142 calculates a limit value. The “limit value” is a level of energy calculated for each of the pixels, and is a maximum value of energy permitted for the scanning rate of the foil transfer tool 60 (described below in more detail). At the set gray scale level of the pixel and the set scanning rate, in the case where the duty value is lower than, or equal to, the limit value, the setter 143 sets the level of energy to be supplied to each pixel to the duty value. In the case where the duty value is higher than the limit value, the setter 143 sets the level of energy to be supplied to each pixel to the limit value. In other words, the setter 143 compares the duty value calculated by the first calculator 141 and the limit value calculated by the second calculator 142 against each other to determine the level of energy to be supplied to each pixel. Upon receipt of the level of energy set by the setter 143, the pulse adjuster 144 adjusts the level of energy to the set level by adjusting the time duration in which the light is supplied. The pulse adjuster 144 transmits pulses to the light source 62 such that the light source 62 is turned on or off at a predetermined timing. The light source 62 is turned on or off at a high speed by the pulses supplied by the pulse adjuster 144. The light source 62 is turned on or off in this manner to adjust the output thereof.

The first calculator 141 calculates the duty value. The duty value is a level of energy calculated for each pixel. The duty value increases as the gray scale level of the pixel is raised, and decreases as the gray scale level of the pixel is lowered. The duty value is set based on an idea that a higher level of energy is required to be supplied to each pixel as the foil transfer is performed at a higher gray scale level. In this preferred embodiment, the duty value is calculated by the following expression.

Du=(Dmax−Dmin)×(PV/PVmax)+Dmin

In the expression, Du is the duty value. Dmax is the maximum value of the output of the light source 62. Dmin is the minimum value of the output of the light source 62 for practical use. Namely, the output of the light source 62 is lower than Dmin, it becomes impossible to perform the foil transfer. PV is the set gray scale level of the pixel. PVmax is the maximum value of the gray scale level, which is 255 in this preferred embodiment. Hereinafter, the above-identified expression may be referred to as “expression 1”.

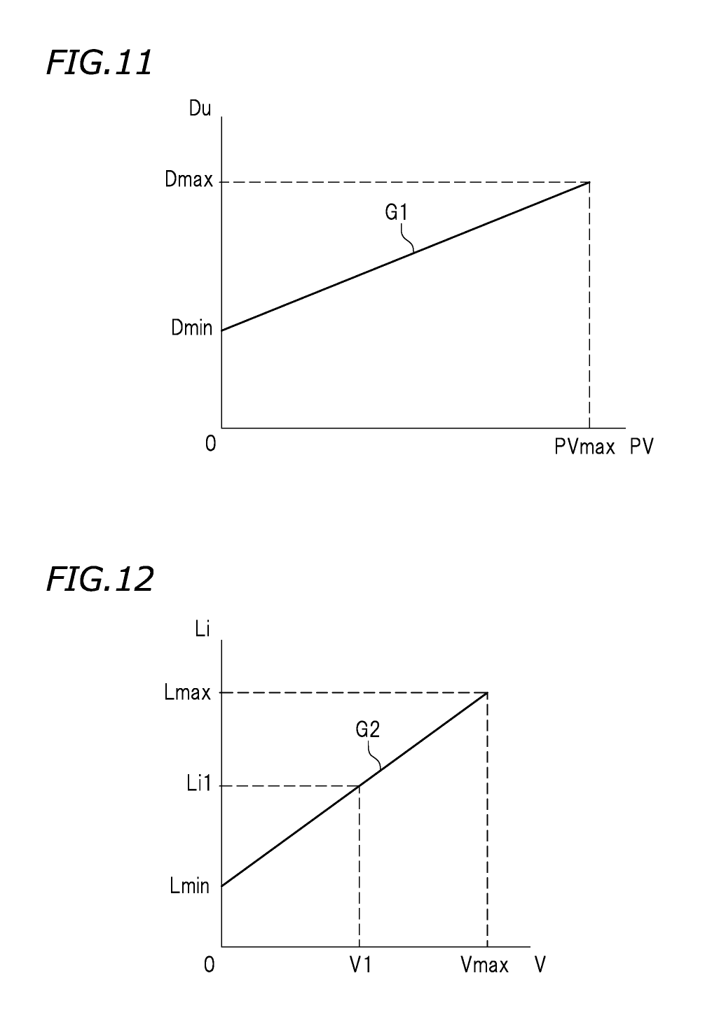

FIG. 11 shows the relationship between the gray scale level PV and the duty value Du in the calculation performed by the first calculator 141. Namely, FIG. 11 is a graph representing expression 1. In FIG. 11, the horizontal axis represents the gray scale level PV of the pixel. The maximum value PV of the gray scale level PV is 255 in this preferred embodiment. In FIG. 11, the vertical axis represents the duty value Du. As shown in FIG. 11, line G1 representing expression 1 is a straight line increasing rightward. Line G1 is a straight line increasing rightward from the minimum value Dmin of the energy at gray scale level 0. Namely, the duty value Du calculated by the first calculator 141 increases from the minimum value Dmin in proportion to the gray scale level PV. As represented by line G1, the duty value Du is the maximum value Dmax at the maximum gray scale level PVmax.

In expression 1, the maximum value Dmax, the minimum value Dmin and the duty value Du may each be an actual value or a relative value with respect to, for example, Dmax as 100%. The maximum value Dmax is set as, for example, a level of energy at which the time duration in which the light is directed from the light source 62 to each pixel is a predetermined time duration (e.g., 250 μs; corresponding to a frequency of 4 kHz). It should be noted that the manner of setting the maximum value Dmax of the output of the light source 62 is not limited to this.

The second calculator 142 calculates the limit value. The limit value is the maximum value of energy for each pixel that is permitted for the scanning rate of the foil transfer tool 60. Namely, the limit value is the maximum level of energy that may be supplied to each pixel. According to the definition of the limit value by the second calculator 142, when the foil transfer tool 60 is scanning at a certain scanning rate, if the light is directed at a level of energy higher than, or equal to, the limit value, a fault may occur. The “fault” is, for example, that the transfer target 80 is burned. In this preferred embodiment, the limit value is represented by expression 2 below.

Li=(Lmax−Lmin)×(V/Vmax)+Lmin

In the expression, Li is the limit value. Lmax is the maximum value of the upper limit of the output of the light source 62. Lmin is the minimum value of the upper limit of the output of the light source 62. V is the set scanning rate of the foil transfer tool 60. Vmax is the maximum value of the scanning rate of the foil transfer tool 60. Vmax is, for example, about 20 mm/sec to about 30 mm/sec.

FIG. 12 shows the relationship between the scanning rate V of the foil transfer tool 60 and the limit value Li. Namely, FIG. 12 is a graph showing expression 2. In FIG. 12, the horizontal axis represents the scanning rate V of the foil transfer tool 60. In FIG. 12, the vertical axis represents the limit value Li. As shown in FIG. 12, line G2 representing expression 2 is a straight line increasing rightward. Line G2 is a straight line increasing rightward from the minimum value Lmin of the limit value at scanning rate 0. Namely, the limit value Li calculated by the second calculator 142 increases from the minimum value Lmin in proportion to the scanning rate V. As represented by line G2, the limit value Li is the maximum value Lmax at the maximum scanning rate Vmax. Namely, the minimum value Lmin of the upper limit of the output of the light source 62 corresponds to scanning rate 0, and the maximum value Lmax corresponds to the maximum scanning rate Vmax. As the scanning rate V of the foil transfer tool 60 is higher, the limit value Li is higher.

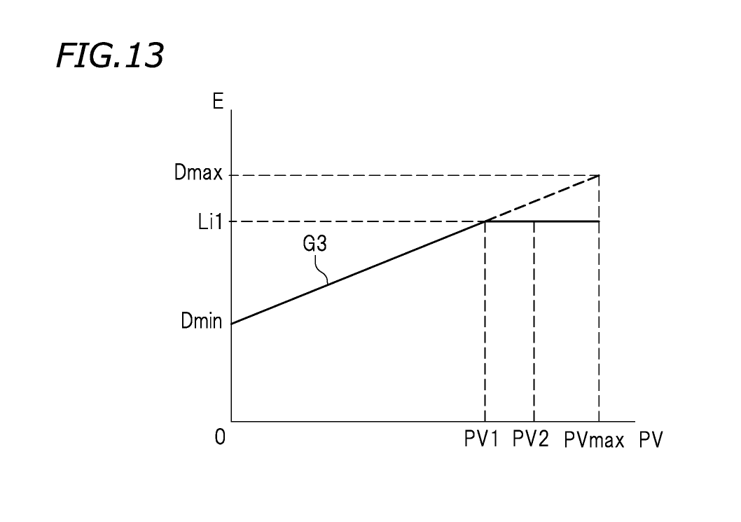

The setter 143 compares the duty value Du calculated by the first calculator 141 and the limit value Li calculated by the second calculator 142 against each other at the set gray scale level PV and the set scanning rate V of the foil transfer tool 60, and thus sets a supply energy level E (see FIG. 13) to be supplied to each pixel. Specifically, at the set gray scale level PV and the set scanning rate V, in the case where the duty value Du is lower than, or equal to, the limit value Li, the setter 143 sets the supply energy level E to the duty value Du. In the case where the duty value Du is higher than the limit value Li, the setter 143 sets the supply energy level E to the limit value Li. Namely, the setter 143 sets the limit value Li as the upper limit, and selects the duty value Du until the limit value Li is reached.

FIG. 13 shows the relationship between the gray scale level PV of the pixel and the supply energy level E when the scanning rate V is V1. In FIG. 13, the horizontal axis represents the gray scale level PV. In FIG. 13, the vertical axis represents the supply energy level E set by the setter 143. As shown in FIG. 13, line G3 representing the supply energy level E matches line G1 in FIG. 11 when the gray scale level PV is low, but shows a constant value Li1 from a certain point. Therefore, line G3 is bent at the certain point. In FIG. 13, output value Li1 is limit value Li1 in FIG. 12. As shown in FIG. 12, limit value Li1 is the limit value Li when the scanning rate V of the foil transfer tool 60 is V1. Namely, line G3 is bent at limit value Li1, at which the scanning rate V=V1. Even when the gray scale level is set to PV2, which is higher than PV1 at the bent point, line G3 is kept at constant output Li1. In the case where the scanning rate V of the foil transfer tool 60 is set to V1, if the set supply energy level E exceeds limit value Li1, a fault such that, for example, the transfer target 80 is burned may occur. Therefore, in this preferred embodiment, the setter 143 sets limit value Li1 corresponding to the scanning rate V1 as the upper limit, and does not increase the output of the light source 62 to a value higher than the upper limit. Needless to say, in the case where the scanning rate V of the foil transfer tool 60 is set to a value at which the duty value Dmax is lower than the limit value Li even at the maximum gray scale level PVmax, the line representing the relationship between the gray scale level PV of the pixel and the supply energy level E is not bent and is a straight line increasing rightward.

Upon receipt of the setting from the setter 143, the pulse adjuster 144 adjusts the energy level to be supplied to each pixel by adjusting the time duration in which the light is directed. Namely, the pulse adjuster 144 adjusts the pulses that actuate the light source 62. For example, it is now assumed that the pulse adjuster 144 transmits a first number of pulses to the light source 62 at a first scanning rate to supply a desired level of energy to each of the pixels. In this case, in the case where the scanning rate is set to n times the first scanning rate, the pulse adjuster 144 transmits n times the first number of pulses to the light source 62 to supply the same level of energy to each of the pixels as in the case where the scanning rate is the first scanning rate. In this manner, in a range where the supply energy level does not reach the limit value, the foil transfer may be performed at a desired gray scale level regardless of the scanning rate.

The supply energy level E to be supplied to each pixel is set as described above. Thus, the foil transfer may be performed basically at a desired gray scale level, and the transfer target 80 may be prevented from being damaged by excessive supply of energy. In addition, the method of adjusting the supply energy level E by adjusting the time duration in which the light source 62 directs light is simple and without fail.

The above-described adjustment of the gray scale level of the pixel may be summarized as follows.

A heat transfer device disclosed herein includes:

a holding table that holds a transfer target having a heat transfer foil placed thereon, the heat transfer foil being heated upon receipt of light;

a foil transfer tool including a light source that directs light toward the heat transfer foil, the foil transfer tool being located above the holding table;

a horizontal moving mechanism that moves the foil transfer tool horizontally with respect to the holding table;

a vertical moving mechanism that moves the foil transfer tool vertically with respect to the holding table and presses the heat transfer foil on the holding table by the foil transfer tool; and

a controller including:
a gray scale level setter that sets a gray scale level for each of pixels in transfer;
a rate setter that sets a rate at which the horizontal moving mechanism moves the foil transfer tool; and
an output adjuster that controls the light source such that the energy level of the light to be directed toward the heat transfer foil is adjusted; wherein
the output adjuster includes:
   a first calculator that calculates a duty value calculated for each of the pixels and set to increase as the gray scale level of the pixel is raised;
   a second calculator that calculates a limit value calculated for each of the pixels and being a maximum value of energy permitted for the rate of the foil transfer tool; and
   a setter that, at the set gray scale level of each of the pixels and the set rate, in the case where the duty value is lower than, or equal to, the limit value, sets the level of energy to be supplied to each pixel to the duty value, and in the case where the duty value is higher than the limit value, sets the level of energy to be supplied to each pixel to the limit value.

With a heat transfer device of such a structure, the energy is supplied basically at the duty value to perform the foil transfer at a desired gray scale level, and the upper limit (limit value) corresponding to the rate (scanning rate) of the foil transfer tool is provided. Thus, the transfer target may be prevented from being damaged by excessive supply of energy.

Another heat transfer device disclosed herein includes, in addition to the elements of the above-described heat transfer device, a feature that the output adjuster includes a pulse adjuster that, upon receipt of the setting of the setter, adjusts the level of energy to be supplied to each pixel by adjusting a time duration in which the light is directed.

Such a heat transfer device may adjust the level of energy to be supplied to each pixel in a simple manner and with certainty.

The heat transfer device 10 in this preferred embodiment checks whether or not the holder 68 is holding the presser 66, and if not, issues a warning. The presser 66 is detachable from the holder 68. If the foil transfer is performed in the state where the holder 68 is not holding the presser 66, it is highly possible that the foil transfer is not performed in a satisfactory manner. Therefore, in this preferred embodiment, the heat transfer device 10 checks whether or not the holder 68 is holding the presser 66 before the foil transfer. In this preferred embodiment, in the case where a plurality of pieces of foil transfer data are input at the same time, the checking is performed once before the first cycle of foil transfer.

As described above, the presser 66 is held at a tip of the holder 68, and a portion of the presser 66 protrudes downward from the bottom end 68a of the holder 68 (see FIG. 6). Therefore, in the state where the holding 68 is holding the presser 66, the bottom end of the foil transfer tool 60 is a bottom end 66a of the presser 66 as shown in FIG. 6. In the state where the holding 68 is not holding the presser 66, the bottom end of the foil transfer tool 60 is the bottom end 68a of the holder 68. In this preferred embodiment, the difference in the height between the bottom end 66a of the presser 66 and the bottom end 68a of the holder 68 is used to check whether or not the holder 68 is holding the presser 66. The difference in the height between the bottom end 66a of the presser 66 and the bottom end 68a of the holder 68 is, for example, about 2 mm.

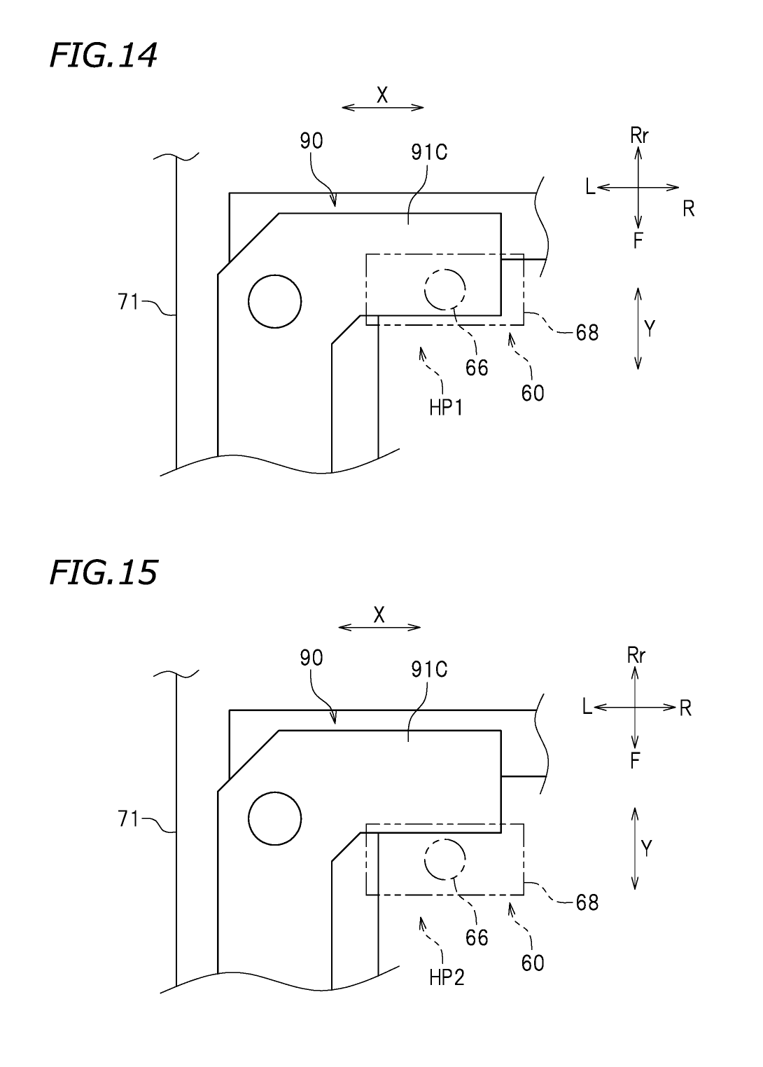

The controller 100 stores two positions in the horizontal direction, more specifically, a first horizontal position and a second horizontal position. In more detail, the first position storage 151 of the holding checker 150 stores the first horizontal position, and the second position storage 152 stores the second horizontal position. The “position in the horizontal direction” is, specifically, the position of the second moving mechanism 40 and the third moving mechanism 50. The first horizontal position and the second horizontal position are respectively stored in the first position storage 151 and the second position storage 152 as the position of the Y-axis direction feed motor 42 and the X-axis direction feed motor 52. FIG. 14 and FIG. 15 are respectively plan views showing a first horizontal position HP1 and a second horizontal position HP2. In FIG. 14, the positions of the presser 66 and the holder 68 when the Y-axis direction feed motor 42 and the X-axis direction feed motor 52 are at the first horizontal position HP1, with the two-dot chain line. In FIG. 15, the positions of the presser 66 and the holder 68 when the Y-axis direction feed motor 42 and the X-axis direction feed motor 52 are at the second horizontal position HP2, with the two-dot chain line. As shown in FIG. 14 and FIG. 15, the first horizontal position HP1 and the second horizontal position HP2 are set to the vicinity of the butt member 90 in the state where the holding frame 72 of the film holder 72A is located at the securing position FP, but are different from each other.

As shown in FIG. 14, the first horizontal position HP1 is a position at which the portion of the holder 68 that is holding the presser 66 is above the inspection surface 91C of the butt member 90. Namely, in the case where the second moving mechanism 40 and the third moving mechanism 50 are at the first horizontal position HP1, the presser 66 overlaps the inspection surface 91C as seen in a plan view.

As shown in FIG. 15, the second horizontal position HP2 is a position at which the portion of the holder 68 that is holding the presser 66 is outward of the inspection surface 91C of the butt member 90 and the portion of the holder 68 that is not holding the presser 66 is above the inspection surface 91C. Namely, in the case where the second moving mechanism 40 and the third moving mechanism 50 are at the second horizontal position HP2, the presser 66 does not overlap the inspection surface 91C, and the bottom end 68a of the holder 68 overlaps the inspection surface 91C, as seen in a plan view. In this preferred embodiment, the second horizontal position HP2 is set at the position of the origin of the second moving mechanism 40 and the third moving mechanism 50. The second horizontal position HP2 is set at such a position in order to make it unnecessary to return the foil transfer tool 60 to the position of the origin after the height at which the foil transfer tool 60 collides against the butt member 90 at the second horizontal position HP2 is measured.

The first measurer 153 of the holding checker 150 measures the height at which the foil transfer tool 60 collides against the inspection surface 91C at the first horizontal position HP1 described above (hereinafter, this height will be referred to as a “first height”). The first measurer 153 first controls the Y-axis direction feed motor 42 and the X-axis direction feed motor 52 such that the head 21 having the foil transfer tool 60 mounted thereon moves to the first horizontal position HP1. Then, the first measurer 153 controls the Z-axis direction feed motor 32 such that the head 21 is lowered. Thus, the first height is measured.

The first height is measured based on the sensing of the sensor 24. In more detail, the first height is determined by the first measurer 153 as the position of the Z-axis direction feed motor 32 when the sensor 24B (see FIG. 6) of the sensor 24 is turned on. When the head 21 is lowered from the state where the holder 68 is holding the presser 66 and the head 21 is at the first horizontal position HP1, the foil transfer tool 60 collides against the inspection surface 91C at the bottom end 66a of the presser 66. When the head 21 is further moved downward to the position at which the protrusion 22A of the head main body 22 presses the switch 24B1 of the sensor 24B, the sensor 24B is turned on. The first measurer 153 grasps the position of the Z-axis direction feed motor 32 at this point as the first height.

In the case where the head 21 is at the first horizontal position HP1 but the holder 68 is not holding the presser 66, when the head 21 is lowered, the foil transfer tool 60 collides against the inspection surface 91C at the bottom end 68a of the holder 68. When the head 21 is further moved downward to the position at which the protrusion 22A of the head main body 22 presses the switch 24B1 of the sensor 24B, the sensor 24B is turned on. The first measurer 153 grasps the position of the Z-axis direction feed motor 32 at this point as the first height. As can be seen, the first height is different in accordance with whether the holder 68 is holding the presser 66 or not.

In this preferred embodiment, after the first height is measured as described above, the head 21 is moved upward by a predetermined distance. Such a moving distance may be any distance with which the head 21 does not interfere with any other component when being horizontally moved to the second horizontal position HP2, and may be, for example, about 10 mm. From this position, the head 21 is moved horizontally to the second horizontal position HP2. The second measurer 154 of the holding checker 150 controls the Y-axis direction feed motor 42 and the X-axis direction feed motor 52 such that the head 21 having the foil transfer tool 60 mounted thereon moves to the second horizontal position HP2. Then, the second measurer 154 controls the Z-axis direction feed motor 32 such that the head 21 is lowered, and measures the height at which the foil transfer tool 60 collides against the inspection surface 91C (hereinafter, this height will be referred to as a “second height”).

The second height is also measured based on the sensing of the sensor 24, like the first height. In more detail, the second height is determined by the second measurer 154 as the position of the Z-axis direction feed motor 32 when the sensor 24B is turned on. In the measurement of the second height, regardless of whether the holder 68 is holding the presser 66 or not, the foil transfer tool 60 collides against the inspection surface 91C at the bottom end 68a of the holder 68. When the head 21 is further moved downward to the position at which the protrusion 22A of the head main body 22 presses the switch 24B1 of the sensor 24B, the sensor 24B is turned on. The second measurer 154 grasps the position of the Z-axis direction feed motor 32 at this point as the second height. The second height is the same regardless of whether the holder 68 is holding the presser 66 or not. The second height is the same as the first height in the state where the holder 68 is not holding the presser 66.

The determiner 155 compares the first height and the second height measured as described above against each other, and determines whether or not the holder 68 is holding the presser 66 based on the comparison result. More specifically, the determiner 155 compares the first height and the second height against each other. In the case where the first height and the second height are equal to each other, the determiner 155 determines that the holder 68 is not holding the presser 66. In the case where the first height is higher than the second height, the determiner 155 determines that the holder 68 is holding the presser 66. As described above, the second height is equal to the first height in the state where the holder 68 is not holding the presser 66. Therefore, in the case where the first height and the second height are equal to each other, it may be determined that the holder 68 is not holding the presser 66. In the state where the holder 68 is holding the presser 66, the first height is higher than the second height by the difference between the height of the bottom end 66a of the presser 66 and the height of the bottom end 68a of the holder 68. Therefore, in the case where the first height is higher than the second height, it may be determined that the holder 68 is holding the presser 66. In the above, the expression that the heights are equal to each other encompasses a case where there is a small difference due to a measurement error.

The warning issuer 156 issues a warning in the case where the determiner 155 determines that the holder 68 is not holding the presser 66. There is no specific limitation on the method of warning. For example, the warning issuer 156 may cause a display of a computer to display a warning screen.

The head 21 is moved to the position of the origin, which is the uppermost position of the movable region thereof in the Z-axis direction, regardless of the determination result of the determiner 155. In the horizontal direction, the second horizontal position HP2 matches the position of the origin. Therefore, the head 21 is already back at the position of the origin. In the case where it is determined that the holder 68 is not holding the presser 66 and a warning is issued, the heat transfer device 10 stops operating at this point. In the case where it is determined that the holder 68 is holding the presser 66, the heat transfer device 10 automatically starts the foil transfer.

In this preferred embodiment, the bottom end 68a of the holder 68 is a flat plane. Therefore, the portion, of the bottom surface of the holder 68, that holds the presser 66, and the other portion of the bottom surface of the holder 68 are at an equal height. The height of the portion holding the presser 68 and the height of the other portion do not need to be equal to each other. For example, a portion of the foil transfer tool 60 that collides against the inspection surface 91C during the measurement of the first height in the state where the holder 68 is not holding the presser 66, and a portion of the foil transfer tool 60 that collides against the inspection surface 91C during the measurement of the second height, may have a height difference from each other. In the case where the difference between the first height and the second height is equal to the above-described height difference, the determiner 155 determines that the holder 68 is not holding the presser 66. In the case where the difference between the first height and the second height is larger than the above-described height difference, the determiner 155 determines that the holder 68 is holding the presser 66. In the case where the bottom end 68a of the holder 68 is a flat plane and the portion thereof holding the presser 68 and the other portion are at an equal height, the above-described height difference is 0. In either case, it is sufficient that a portion of the presser 66 protrudes downward from the bottom end 68a of the holder 68.

As described above, in this preferred embodiment, the heat transfer device 10 includes the butt member 90 including the inspection surface 91C that is directed upward and located in the movable region of the foil transfer tool 60, and determines whether or not the holder 68 is holding the presser 66 based on the height at which the foil transfer tool 60 collides against the inspection surface 91C. More specifically, in this preferred embodiment, the first measurer 153 measures the first height, at which the foil transfer tool 60 collides against the inspection surface 91C when the second head moving mechanism 40 and the third head moving mechanism 50 are at the first horizontal position HP1, at which the portion of the holder 68 that is holding the presser 66 is above the inspection surface 91C. In this preferred embodiment, the second measurer 154 measures the second height, at which the foil transfer tool 60 collides against the inspection surface 91C when the second head moving mechanism 40 and the third head moving mechanism 50 are at the second horizontal position HP2, at which the portion of the holder 68 that is holding the presser 66 is outward of the inspection surface 91C and the portion of the bottom end 68a of the holder 68 that is not holding the presser 66 is above the inspection surface 91C. The determiner 155 compares the first height and the second height against each other. In the case where the difference between the first height and the second height is smaller than, or equal to, a predetermined value, the determiner 155 determines that the holder 68 is not holding the presser 66. In the case where the difference between the first height and the second height is larger than the predetermined value, the determiner 155 determines that the holder 68 is holding the presser 66. The determiner 155 is allowed to make such determinations because the holder 68 holds the presser 66 such that a portion of the presser 66 protrudes downward from the bottom end 68a of the holder 68. In this manner, the heat transfer device 10 may determine whether or not the holder 68 is holding the presser 66.

In this preferred embodiment, the heat transfer device 10 includes the sensor 24 sensing that the foil transfer tool 60 has been pressed upward. Based on the sensing of the sensor 24, the first measurer 153 measures the first height. Based on the sensing of the sensor 24, the second measurer 154 measures the second height. This will be described in more detail. The sensor 24 includes the slide mechanism 24A holding the holder 68 such that the holder 68 is movable in the up-down direction and the sensor 24B sensing that the holder 68 has moved upward with respect to the slide mechanism 24A. The sensor 24B senses that the foil transfer tool 60 has collided against the inspection surface 91C of the butt member 90. In the heat transfer device 10, it is directly sensed that the foil transfer tool 60 has collided against the inspection surface 91C. Therefore, it may be determined with certainty whether the holder 68 is holding the presser 66 or not.

In the present preferred embodiment, the heat transfer device 10 preferably further includes the warning issuer 156 that issues a warning in the case where the determiner 155 determines that the holder 68 is not holding the presser 66. Therefore, it may be notified to the user or the like that the holder 68 is not holding the presser 66.

In this preferred embodiment, it is checked automatically whether or not the holder 68 is holding the presser 66 before the foil transfer. Alternatively, it may be checked manually, at any appropriate time, whether or not the holder 68 is holding the presser 66. There is no specific limitation on the timing or frequency at which it is checked whether or not the holder 68 is holding the presser 66. In such checking, the first height and the second height may be measured in the opposite order. It is not absolutely necessary that either the first horizontal position HP1 or the second horizontal position HP2 is set to the position of the origin in the horizontal direction. In this preferred embodiment, the first horizontal position HP1 and the second horizontal position HP2 are determined based on the positions of the Y-axis direction feed motor 42 and the X-axis direction feed motor 52. Alternatively, the first horizontal position HP1 and the second horizontal position HP2 may be determined by, for example, a sensor such as a limit switch or the like. In such a case, the first position storage 151 stores the first horizontal position HP1 as the position at which a sensor for the X-axis direction reacts. The second position storage 152 stores the second horizontal position HP2 as the position at which a sensor for the Y-axis direction reacts.

Some preferred embodiments of the present invention have been described. The above-described preferred embodiments are merely examples, and the present invention may be carried out in any of various forms. For example, in the above-described preferred embodiments, the butt member 90 is provided as a dedicated member. Alternatively, any other member may also act as the butt member 90. For example, the holding frame 72 or the like may be used as the butt member 90.

In the above-described preferred embodiments, the collision of the foil transfer tool 60 against the butt member 90 is sensed by the sensor 24 including the slide mechanism 24A holding the head main body 24 such that the head main body 24 is movable in the up-down direction and the sensor 24B. Such collision may be sensed by any other mechanism. For example, a pressure sensor may sense that the foil transfer tool 60 has pressed the butt member 90.

In the above-described preferred embodiments, the foil transfer tool 60 moves in the X-axis direction, the Y-axis direction and the Z-axis direction, whereas the holding table 70 is immovable. The present invention is not limited to this. The movement of the foil transfer tool 60 and the holding table 70 is relative to each other. There is no specific limitation on which one of the foil transfer tool 60 and the holding table 70 moves or on the direction in which the movement is made.

In the above-described preferred embodiments, the light source 62 is provided in an energy generator. The energy generator provides the heat transfer foil 82 with energy directly or indirectly, and is not limited to including the light source 62. The energy generator may be, for example, a heater or the like. In such a case, the heat transfer device 10 may include a thermal pen instead of the laser pen.

In the above-described preferred embodiments, the heat transfer device 10 performs all the operations of adjusting the value of electric current to be supplied to the light source 62, adjusting the output of the light source 62 in accordance with the gray scale level of the pixel and the scanning rate of the foil transfer tool 60, and checking whether or not the holder 68 is holding the presser 66. The heat transfer device 10 may perform one or two among these operations. The adjustment of the value of electric current to be supplied to the light source 62, the adjustment of the output of the light source 62 in accordance with the gray scale level of the pixel and the scanning rate of the foil transfer tool 60, and the checking on whether or not the holder 68 is holding the presser 66 may each be performed independently.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principles of the present invention. These preferred embodiments are provided with the understanding that they are not intended to limit the present invention to the preferred embodiments described in the specification and/or shown in the drawings. The present invention is not limited to the preferred embodiments described herein. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or used during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A heat transfer device, comprising:
a holding table that holds a transfer target having a heat transfer foil placed thereon;
a foil transfer tool including an energy generator that generates energy to be supplied to the heat transfer foil and a holder that is capable of holding a presser that presses the heat transfer foil and transmits the energy to the heat transfer foil, the foil transfer tool being located above the holding table;
a horizontal conveyor that moves the foil transfer tool horizontally with respect to the holding table;
a vertical conveyor that moves the foil transfer tool vertically with respect to the holding table and presses the heat transfer foil on the holding table by the foil transfer tool;
a butt that includes an inspection surface directed upward and located in a movable region of the foil transfer tool; and
a controller; wherein
the holder is located at a bottom end of the foil transfer tool and holds the presser such that a portion of the presser protrudes downward from a bottom end of the holder; and
the controller includes:
a first position storage that stores a first horizontal position as a position of the horizontal conveyor at which a holding portion of the holder that is holding the presser is above the inspection surface;
a second position storage that stores a second horizontal position as a position of the horizontal conveyor at which the holding portion of the holder is outward of the inspection surface and a portion of the bottom end of the holder other than the holding portion is above the inspection surface;
a first measurer that controls the horizontal conveyor such that the foil transfer tool moves to the first horizontal position, and then controls the vertical conveyor such that a first height at which the foil transfer tool collides against the inspection surface is measured;
a second measurer that controls the horizontal conveyor such that the foil transfer tool moves to the second horizontal position, and then controls the vertical conveyor such that a second height at which the foil transfer tool collides against the inspection surface is measured; and
a determiner that compares the first height and the second height to each other, and when a difference between the first height and the second height is smaller than, or equal to, a predetermined difference, determines that the holder is not holding the presser, and when the difference between the first height and the second height is larger than the predetermined difference, determines that the holder is holding the presser.

2. The heat transfer device according to claim 1, further comprising a sensor that senses that the foil transfer tool has been pressed upward; wherein
the first measurer measures the first height based on the sensing of the sensor; and
the second measurer measures the second height based on the sensing of the sensor.

3. The heat transfer device according to claim 2, wherein the sensor includes:
a holder conveyor that holds the holder such that the holder is movable in an up-down direction; and
a sensor that senses that the holder has moved upward with respect to the holder conveyor.

4. The heat transfer device according to claim 1, wherein the controller includes a warning issuer that issues a warning when the determiner determines that the holder is not holding the presser.

5. The heat transfer device according to claim 1, wherein
the energy generator includes a light source; and
the heat transfer foil is transferred by use of the energy of light emitted by the light source.
